(19) United States
(12) Patent Application Publication
(10) Pub. No.: US 2026/0189457 A1
(43) Pub. Date: Jul. 2, 2026

(54) SMART POLICY RULE UPDATE

(71) Applicant: Telefonaktiebolaget LM Ericsson (publ), Stockholm (SE)

(72) Inventors: Jinyang XIE, Shanghai (CN); Susana Fernandez ALONSO, Madrid (ES); Hong ZHANG, Goeteborg (SE); Yunjie LU, Shanghai (CN)

(73) Assignee: Telefonaktiebolaget LM Ericsson (publ), Stockholm (SE)

(21) Appl. No.: 19/123,130

(22) PCT Filed: Aug. 21, 2023
(86) PCT No.: PCT/CN2023/113985

§ 371 Date: Apr. 22, 2025

(30) Foreign Application Priority Data
Oct. 30, 2022 (WO) PCT/CN2022/128465

(51) Int. Cl. H04L 41/082; H04L 41/0677

(52) U.S. Cl. CPC H04L 41/082; H04L 41/0677

(57) ABSTRACT

In some embodiments, a method is performed by a second network function implementing a Session Management Function (SMF). The method may include receiving, from a first network function implementing an Access and Mobility Management Function (AMF), a first message including a first parameter indicating a first retry-after time. The first retry-after time may indicate the second network function to stop sending a message for a User Equipment (UE) before the first retry-after time is timeout. The method may further include transmitting, to a third network function implementing a Policy Control Function (PCF), a second message including a second parameter indicating a second retry-after time during which the UE is considered unreachable. The embodiments may reduce the signal exchange between the PCF and the SMF when the UE is not reachable or the UE is busy on other procedures.

### CROSS REFERENCE TO RELATED APPLICATION

This application claims priority of PCT Application Serial Number PCT/CN2022/128465 filed on Oct. 30, 2022 with title of “SMART POLICY RULE UPDATE”, the entire contents of which are incorporated herein by reference.

### TECHNICAL FIELD

The embodiments herein relate generally to the field of mobile communication, and more particularly, the embodiments herein relate to smart policy rule update.

### BACKGROUND

FIG. 1 is a schematic block diagram showing example architecture 100 for 5G network architecture at non-roaming scenario. In the 5G network, the network requested Packet Data Unit (PDU) session modification procedure is used when the network initiates a PDU session modification to a User Equipment (UE) 106. FIG. 2 is a schematic signaling chart showing the messages in an example network requested PDU session modification procedure. As shown in FIG. 2, the Policy Control Function (PCF) 103 may invoke a session management policy control update notify service operation for installing new/modified Policy Control and Charging (PCC) rule(s).

### SUMMARY

It is noted that, in the current network requested PDU session modification procedure, there is no mechanism to indicate the PCF and then an Application Function (AF) that a failure is related to a temporary situation which is not related with the lack of resources and may be resolved when the UE becomes reachable.

The embodiments herein propose methods, network functions, computer readable mediums and computer program products for smart policy rule update.

In some embodiments, there proposes a method performed by a second network function implementing a Session Management Function (SMF). The method may comprise the step of receiving, from a first network function implementing an Access and Mobility Management Function (AMF), a first message including a first parameter indicating a first retry-after time. The first retry-after time may indicate the second network function to stop sending a message for a UE before the first retry-after time is timeout. The method may further comprise the step of transmitting based on the first message, to a third network function implementing a PCF, a second message including a second parameter indicating a second retry-after time during which the UE is considered unreachable.

In an embodiment, the second retry-after time may be set based on the first retry-after time.

In an embodiment, the first and second messages each may further include a fourth parameter indicating a failure cause. In an embodiment, the failure cause may be that the UE is temporarily unavailable.

In an embodiment, the method may further comprise the step of receiving, from the third network function, a fifth message for retrying the failed policy update or sending the buffered changes, after the retry-after timer expires.

In an embodiment, the first message may be N1N2 message transfer response message or N1N2 message transfer failure notification message. In an embodiment, the second message may be a session management policy control update request message. In an embodiment, the fifth message may be a session management policy control update notify request message.

In some embodiments, there proposes a method performed by a third network function implementing a PCF. The method may comprise the step of receiving, from a second network function implementing a SMF, a second message including a second parameter indicating a second retry-after time during which a UE is considered unreachable. The method may further comprise the step of transmitting, to a fourth network function implementing an AF, a third message including a third parameter indicating a third retry-after time. The third retry-after time may indicate the fourth network function to suppress a transfer of message to the third network function when the third retry-after time runs.

In an embodiment, the second and third messages each may further include a fourth parameter indicating a failure cause. In an embodiment, the failure cause may be that the UE is temporarily unavailable.

In an embodiment, the method may further comprise the step of receiving, from the fourth network function, a subscription on a failure event. In an embodiment, the third message may be transmitted in response to the failure event.

In an embodiment, the method may further comprise the step of receiving, from the fourth network function, a fourth message for retrying the provisioning of application or service information, after the third retry-after time expires.

In an embodiment, the method may further comprise the step of transmitting, to the second network function, a fifth message for retrying the failed policy update or sending the buffered changes, in response to the fourth message.

In an embodiment, the second message may be a session management policy control update request message. In an embodiment, the third message may be an event reporting message. In an embodiment, the fourth message may be an application/service information provisioning message. In an embodiment, the fifth message may be a session management policy control update notify request message.

In an embodiment, the session management policy may be a PCC rule.

In some embodiments, there proposes a method performed by a fourth network function implementing an AF. The method may comprise the step of receiving, from a third network function implementing a PCF, a third message including a third parameter indicating a third retry-after time. The third retry-after time may indicate the fourth network function to suppress a transfer of message to the third network function during the third retry-after time.

In an embodiment, the method may further comprise the step of starting a retry-after timer according to the third parameter, to suppress a transfer of message to the third network function when the retry-after timer runs.

In an embodiment, the third message may further include a fourth parameter indicating a failure cause. In an embodiment, the failure cause may be that a UE is temporarily unavailable.

In an embodiment, the method may further comprise the step of transmitting, to the third network function, a subscription on a failure event. In an embodiment, the third message may be transmitted in response to the failure event.

In an embodiment, the method may further comprise the step of transmitting, to the third network function, a fourth message for retrying the provisioning of application or service information, after the retry-after timer expires.

In an embodiment, the third message may be an event reporting message. In an embodiment, the fourth message may be a session management policy control update notify request message.

In an embodiment, the session management policy may be a PCC rule.

In some embodiments, there proposes a network function. In an embodiment, the network function may comprise at least one processor; and a non-transitory computer readable medium coupled to the at least one processor. The non-transitory computer readable medium may store instructions executable by the at least one processor, whereby the at least one processor may be configured to perform any of the above methods. In an embodiment, the network function may be configured as the first network function, the second network function, the third network function, or the fourth network function.

In some embodiments, there proposes a computer readable medium comprising computer readable code, which when run on an apparatus, may cause the apparatus to perform any of the above methods.

In some embodiments, there proposes a computer program product comprising computer readable code, which when run on an apparatus, may cause the apparatus to perform any of the above methods.

The embodiments may reduce the signal exchange between the PCF and the SMF and between the AF and the PCF when the UE is not reachable or the UE is busy on other procedures. In addition, the embodiments may reduce paging from the AMF and may save Radio Access Network (RAN) resources.

### BRIEF DESCRIPTION OF THE DRAWINGS

The accompanying drawings, which are incorporated herein and form part of the specification, illustrate various embodiments of the present disclosure and, together with the description, further serve to explain the principles of the disclosure and to enable a person skilled in the pertinent art to make and use the embodiments disclosed herein. In the drawings, like reference numbers indicate identical or functionally similar elements, and in which:

FIG. 1 is a schematic block diagram showing example architecture for 5G network architecture at non-roaming scenario;

FIG. 2 is a schematic signaling chart showing the messages in an example network requested PDU session modification procedure;

FIG. 3 is a schematic signaling chart showing the messages in an example procedure for improved message suppress sequence flow, according to the embodiments herein;

FIG. 4 is a schematic signaling chart showing the messages in another example procedure for improved message suppress sequence flow, according to the embodiments herein;

FIG. 5 is a schematic flow chart showing an example method in the second network function, according to the embodiments herein;

FIG. 6 is a schematic flow chart showing an example method in the third network function, according to the embodiments herein;

FIG. 7 is a schematic flow chart showing an example method in the fourth network function, according to the embodiments herein;

FIG. 8 is a schematic block diagram showing an example second network function, according to the embodiments herein;

FIG. 9 is a schematic block diagram showing an example third network function, according to the embodiments herein;

FIG. 10 is a schematic block diagram showing an example fourth network function, according to the embodiments herein; and

FIG. 11 is a schematic block diagram showing an example computer-implemented apparatus, according to the embodiments herein.

### DETAILED DESCRIPTION OF EMBODIMENTS

Embodiments herein will be described in detail hereinafter with reference to the accompanying drawings, in which embodiments are shown. These embodiments herein may, however, be embodied in many different forms and should not be construed as being limited to the embodiments set forth herein. The elements of the drawings are not necessarily to scale relative to each other.

Reference to “one embodiment” or “an embodiment” means that a particular feature, structure or characteristic described in connection with the embodiment is included in at least one embodiment. Thus, the appearances of the phrase “in an embodiment” appearing in various places throughout the specification are not necessarily all referring to the same embodiment.

The term “A, B, or C” used herein means “A” or “B” or “C”; the term “A, B, and C” used herein means “A” and “B” and “C”; the term “A, B, and/or C” used herein means “A”, “B”, “C”, “A and B”, “A and C”, “B and C” or “A, B, and C”.

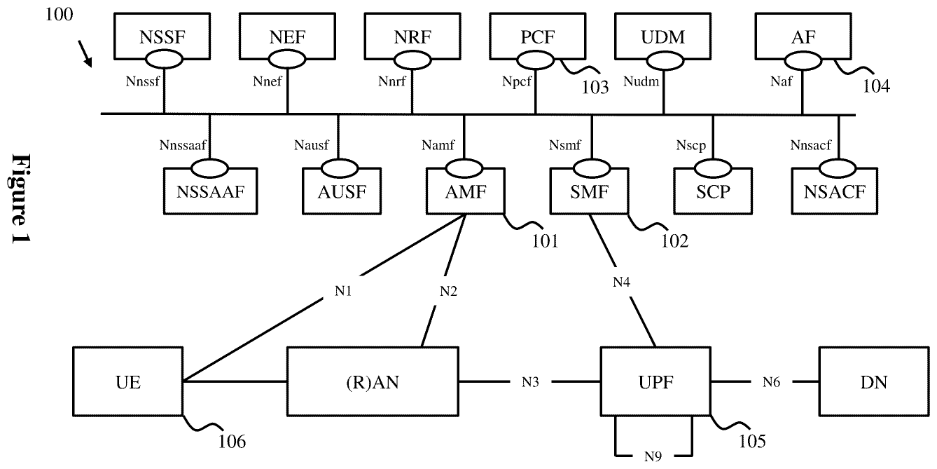

The embodiments may be implemented in the example architecture 100 as shown in FIG. 1.

In an embodiment, the example architecture 100 may be configured in an Over The Top (OTT) scenario. The OTT connection may be transparent in the sense that the participating communication devices through which the OTT connection passes are unaware of routing of uplink and downlink communications. For example, a base station may not or needs not be informed about the past routing of an incoming downlink communication with data originating from the network functions (such as the AMF 101, SMF 102, PCF 103, AF 104, or User Plane Function (UPF) 105) in the core network to be forwarded (e.g., handed over) to a connected UE 106. Similarly, the base station needs not be aware of the future routing of an outgoing uplink communication originating from the UE 106 towards the network functions (such as the AMF 101, SMF 102, PCF 103, AF 104, or UPF 105) in the core network.

It should also be understood that, a network function (such as the AMF 101, SMF 102, PCF 103, AF 104, or UPF 105 in FIG. 1) can be implemented either as a network element on a dedicated hardware, as a software instance running on a dedicated hardware, or as a virtualized function instantiated on an appropriate platform, e.g., on a cloud infrastructure.

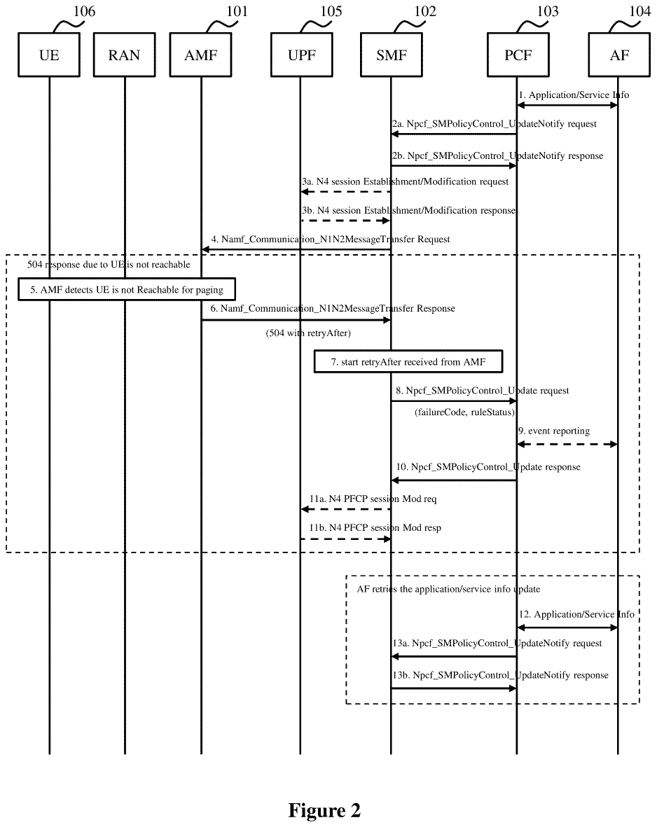

UE or network requested PDU Session Modification The network requested PDU session modification procedure in FIG. 2 may include the following messages or steps:
Step 1. The AF 104 may provide the application/service information to the PCF 103 by invoking the sending of Npcf_PolicyAuthorization service (could be the creation, update or termination of an AF session). The PCF 103 may reply back.
Step 2. The PCF 103 may make a policy decision. The PCF 103 may determine that updated or new policy information needs to be sent to the SMF 102:
Step 2a. (PCF initiated Session Management (SM) policy association modification). The PCF 103 may perform a PCF initiated SM policy association modification procedure to notify the SMF 102 about the modifications of policies.
Step 2b. The SMF 102 may acknowledge the PCF request with a Npcf_SMPolicyControl_UpdateNotify response.
Step 3. The SMF 102 may initiate the N4 session establishment or modification procedure for new or modified Quality of Service (QoS) flow(s).
Step 3a. The SMF 102 may update the UPF 105 with N4 Rules related to new or modified QoS Flow(s).
Step 3b. The UPF(s) 105 may respond to the SMF 102.
Step 4. For SMF requested modification, the SMF 102 may invoke Namf_Communication_N1N2MessageTransfer ([N2 SM information] (PDU session ID, QFI(s), QoS profile(s), [alternative QoS profile(s)], session-AMBR, [CN tunnel info(s)], QoS monitoring indication, QoS monitoring reporting frequency, [TSCAI(s)]), N1 SM container (PDU session modification command (PDU session ID, QoS rule(s), QoS flow level QoS parameters if needed for the QoS flow(s) associated with the QoS rule(s), Qos rule operation and QoS flow level QoS parameters operation, session-AMBR))).
Step 5. The AMF 101 may detect that the UE is not reachable for paging.
Step 6. The AMF 101 may respond with the status code “504 Gateway Timeout”. The AMF 101 may set the application error as “UE_TEMPORARILY_UNAVAILABLE” in POST response body, and the AMF 101 may set a retry-after to request the SMF 102 to stop sending the N1/N2 message before timeout.
Step 7. The SMF 102 may start a retry-after timer to prevent from sending the N1/N2 message before the retry-after timer is timeout.
Step 8. The SMF 102 may send Npcf_SMPolicyControl_Update request to report the failure of the enforcement of the PCC rule(s).
Step 9. When the AF 104 has subscribed to receive notification about the outcome of the resource allocation, the PCF 103 may report the event to the AF 104 by invoking the Npcf_PolicyAuthorization_Notify service operation.
Step 10. The PCF 103 may answer with a Npcf_SMPolicyControl_Update response.
Step 11. The SMF 102 may send the UPF 105 session release or modification procedure to roll back the new or modified QoS flow(s) if the N4 rules were setup or modified in step 2.
Step 12. The AF 104 may retry the application/service information to the PCF 103.
Step 13. The PCF 103 may execute the SM policy association modification procedure again. It is possible that same failure may be happened since the UE is not reachable.

There is a situation, when the PCF 103 invokes an Npcf_SMPolicyControl_UpdateNotify service operation for the installation of new/modified PCC rules, the SMF 102 will send the Namf_N1N2MessageTransfer request to transfer N1 and N2 information through the AMF 101. The SMF 102 may receive HTTP 409 or 504 status code as a response to Namf_N1N2MessageTransfer request with a “Retry Timer” Information Element (IE) from the AMF 101 (which means the UE 106 is not reachable at the moment it was contacted, and the AMF 101 asks the SMF 102 to retry after the retry-after timer expires).

In this case, the SMF 102 needs to report an error to the PCF 103 since the PCC rules could not be successfully installed/modified, and this error should be reported to the AF 104. However, there is no specified error to indicate the PCF 103 and then AF 104 that the failure is related to a temporary situation, and that the PCF 103 (based on the AF request) should not retry the installation of PCC Rules for that UE during the specific time that has been indicated by the AMF 101 to the SMF 102 or is locally configured in the SMF 102.

Currently, Npcf_SMPolicyControl_Update or Npcf_PolicyAuthorization_Notify request message body lacks the knowledge to make the PCF 103 or AF 104 be aware of what the problem is, when the situation is reverted, and when appropriate decisions can be made in the PCF 103 and/or the AF 104 (e.g. reattempt of the service or changing policy information).

In view of the above deficiencies, the embodiments herein propose introducing a new “retry After” attribute in the “RuleReport” data type to indicate the “retry-after timer” IE received by the SMF 102 from the AMF 101 so that the PCF 103 does not initiate the installation of PCC rule(s) during the AMF-estimated time that the UE 106 is considered unreachable or there is an ongoing registration procedure or an ongoing Xn or N2 handover procedure.

In addition, a new failure code value is defined, “UE_TEMPORARILY_UNAVAILABLE”, to inform the PCF 103 that the PCC rules were not successfully installed/modified because the UE 106 was not reachable.

In addition, a new feature “UEUnreachable” is defined to introduce the handling of a new event “UE_TEMPORARILY_UNAVAILABLE” associated to an optional timer (i.e., retry-after timer) within “AfEventNotification” data type in order to report the case to the AF 104, when the AMF 101 could not accept the resource modification due to the unreachability of the UE 106.

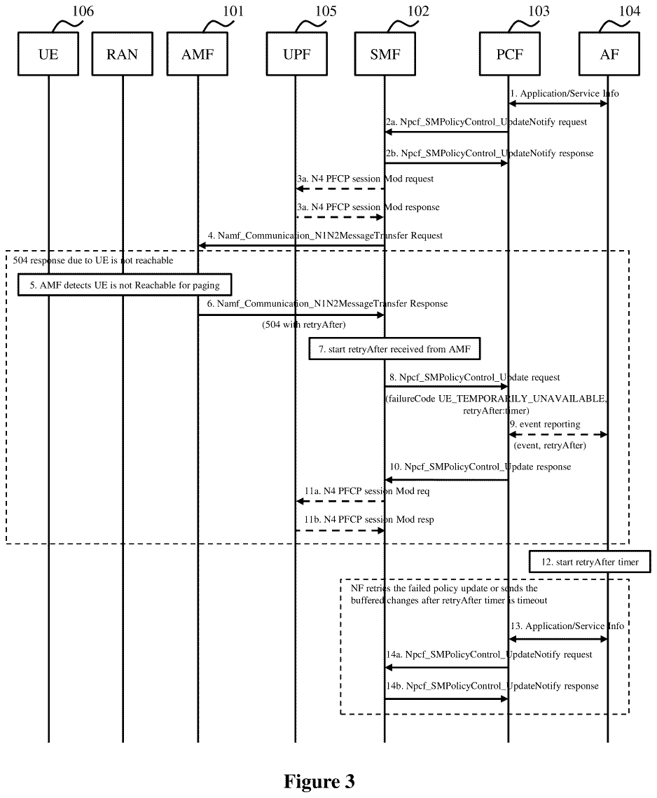

FIG. 3 is a schematic signaling chart showing the messages in an example procedure for improved message suppress sequence flow, according to the embodiments herein. FIG. 3 describes the improved message suppress sequence flow due to UE is not reachable.

In an embodiment, the procedure for improved message suppress sequence flow in FIG. 3 may include the following messages or steps:
Step 1. The AF 104 may provide the application/service information to the PCF 103 by invoking Npcf_PolicyAuthorization service.
Step 2. The PCF 103 may make a policy decision. The PCF 103 may determine that updated or new policy information needs to be sent to the SMF 102:
Step 2a. (PCF initiated SM policy association modification). The PCF 103 may perform a PCF initiated SM policy association modification procedure to notify the SMF 102 about the modifications of policies.
Step 2b. The SMF 102 may acknowledge the PCF request with a Npcf_SMPolicyControl_UpdateNotify response.
Step 3. The SMF 102 may initiate the N4 session establishment or modification procedure for new or modified QoS flow(s).
Step 3a. The SMF 102 may update the UPF 105 with N4 rules related to new or modified QoS flow(s).
Step 3b. The UPF(s) 105 may respond to the SMF 102.
Step 4. For SMF requested modification, the SMF 102 may invoke Namf_Communication_N1N2MessageTransfer ([N2 SM information] (PDU session ID, QFI(s), QoS profile(s), [alternative QoS profile(s)], session-AMBR, [CN tunnel info(s)], QoS monitoring indication, QoS monitoring reporting frequency, [TSCAI(s)]), N1 SM container (PDU session modification command (PDU session ID, QoS rule(s), QoS flow level QoS parameters if needed for the QoS flow(s) associated with the QoS rule(s), QoS rule operation and QoS flow level QoS parameters operation, Session-AMBR))).
Step 5. The AMF 101 may detect that the UE 106 is not reachable for paging.
Step 6. The AMF 101 may respond with the status code “504 Gateway Timeout”. The AMF 101 may set the application error as “UE_NOT_REACHABLE” in POST response body, and the AMF 101 may set a retry-after (a first retry-after timer) to request the SMF 102 to stop sending the N1/N2 message before timeout.
Step 7. If the retry-after timer is received, the SMF 102 may start the retry-after timer according to the received timer. Otherwise, it can set the retry-after timer based on local configuration, to suppress sending the N1/N2 message before the retry-after timer is timeout.
Step 8. The SMF 102 may send Npcf_SMPolicyControl_Update request to report the failure of the enforcement of the PCC rule(s), including failure code “UE_TEMPORARILY_UNAVAILABLE” and a retry-after timer (a second retry-after timer).
Step 9. When the AF 104 has subscribed to the related event, the PCF 103 may report the event “UE_TEMPORARILY_UNAVAILABLE” with a retry-after timer (a third retry-after timer) to the AF 104 by invoking the Npcf_PolicyAuthorization_Notify service operation. The AF 104 may reply back.

In an example, a new “retryAfter” attribute is introduced in the “RuleReport” data type for step 8 and/or step 9, so that the AF 104 does not reattempt to provide the application/service information to the PCF 103 or the PCF 103 does not initiate the installation of PCC rule(s) during the AMF-estimated time (the first retry-after time) or the SMF-estimated time (the second retry-after time) that the UE 106 is considered unreachable.

In addition, a new failure code value, “UE_TEMPORARILY_UNAVAILABLE” is introduced, to inform the PCF 103 and the AF 104 what's the problem is.

In an example, the step 8 and/or step 9 may include the RuleReport in the table 1.

TABLE 1
Definition of type RuleReport

| Attribute name | Data type | P | Cardinality | Description | Applicability |
|---|---|---|---|---|---|
| pccRuleIds | array(string) | M | 1 . . . N | Contains the identifier(s) of the affected | |
| | | | | PCC rule(s). | |
| ruleStatus | RuleStatus | M | 1 | Indicates the status of the PCC rule(s). | |
| contVers | array(ContentVersion) | C | 1 . . . N | Indicates the version(s) of the PCC | RuleVersioning |
| | | | | rule(s). If the RuleVersioning feature is | |
| | | | | supported, the content version shall be | |
| | | | | included in this attribute if it was | |
| | | | | included when the corresponding PCC | |
| | | | | rule was installed or modified. | |
| failureCode | FailureCode | C | 0 . . . 1 | Indicates the reason why the PCC | |
| | | | | Rule(s) are being reported. It shall be | |
| | | | | included when the NF service | |
| | | | | consumer reports the failure of the | |
| | | | | enforcement of the PCC rule(s). | |
| retryAfter | Uinteger | O | 0 . . . 1 | Indicates the estimate on how long it | UEUnreachable |
| | | | | will take before it can be considered the | |
| | | | | UE is reachable or how long the | |
| | | | | ongoing procedure is completed. | |
| | | | | It may be provided when the | |
| | | | | failureCode attribute indicates | |
| | | | | UE_TEMPORARILY_UNAVAILABLE. | |
| finUnitAct | FinalUnitAction | O | 0 . . . 1 | Contains the related filter parameters | |
| | | | | and redirect address parameters (if | |
| | | | | available), when the user's account | |
| | | | | cannot cover the service cost. | |
| ranNasRelCauses | array(RanNasRelCause) | O | 1 . . . N | Indicates the RAN or NAS release | RAN-NAS-Cause |
| | | | | cause code information. | |
| altQosParamId | string | O | 0 . . . 1 | Indicates the alternative QoS | AuthorizationWithRequiredQoS |
| | | | | parameter set that the NG-RAN can | |
| | | | | guarantee. It is included during the | |
| | | | | report of success resource allocation | |
| | | | | and indicates that NG-RAN used an | |
| | | | | alternative QoS profile because the | |
| | | | | requested QoS could not be allocated. | |

In an example, the step 8 and/or step 9 may further include the failure code in the table 2.

TABLE 2
Enumeration FailureCode

| Enumeration value | Description | Applicability |
|---|---|---|
| UNK_RULE_ID | Indicates that the pre-provisioned PCC rule could not be | |
| | successfully activated because the provided PCC rule identifier is | |
| | unknown to the NF service consumer. | |
| RA_GR_ERR | Indicates that the PCC rule could not be successfully installed or | |
| | enforced because the Rating Group specified within the Charging | |
| | Data policy decision to which the PCC rule refers is unknown or | |
| | invalid. | |
| SER_ID_ERR | Indicates that the PCC rule could not be successfully installed or | |
| | enforced because the Service Identifier specified within the | |
| | Charging Data policy decision to which the PCC rule refers is | |
| | invalid, unknown or not applicable to the service being charged. | |
| NF_MAL | Indicates that the PCC rule could not be successfully installed (for | |
| | those provisioned from the PCF), activated (for those pre-defined | |
| | in the SMF) or enforced (for those already successfully installed) | |
| | due to SMF/UPF malfunction. | |
| RES_LIM | Indicates that the PCC rule could not be successfully installed (for | |
| | those provisioned from the PCF), activated (for those pre-defined | |
| | in the SMF) or enforced (for those already successfully installed) | |
| | due to a limitation of resources at the SMF/UPF. | |
| MAX_NR_QoS_FLOW | Indicates that the PCC rule could not be successfully installed (for | |
| | those provisioned from the PCF), activated (for those pre-defined | |
| | in the SMF) or enforced (for those already successfully installed) | |
| | due to the fact that the maximum number of QoS flows has been | |
| | reached for the associated PDU session. | |
| MISS_FLOW_INFO | Indicates that the PCC rule could not be successfully installed | |
| | (for those provisioned from the PCF) or enforced (for those | |
| | already successfully installed) because neither the “flowInfos” | |
| | attribute nor the “appId” attribute is specified by the PCF within the | |
| | PCC rule entry of the “pccRules” attribute during the first PCC rule | |
| | installation request. | |
| RES_ALLO_FAIL | Indicates that the PCC rule could not be successfully installed or | |
| | maintained since the associated QoS flow | |
| | establishment/modification failed or the associated QoS flow was | |
| | released. | |
| UNSUCC_QOS_VAL | This value is used to: | |
| | indicate that QoS validation has failed; or | |
| | indicate when Guaranteed Bandwidth > | |
| | Max-Requested-Bandwidth. | |
| INCOR_FLOW_INFO | Indicates that the PCC rule could not be successfully installed or | |
| | modified at the NF service consumer because the provided flow | |
| | information is not supported by the network (e.g. the provided IP | |
| | address(es) or Ipv6 prefix(es) do not correspond to an IP version | |
| | applicable for the PDU session). | |
| PS_TO_CS_HAN | Indicates that the PCC rule could not be maintained because of | |
| | PS to CS handover. | |
| APP_ID_ERR | Indicates that the PCC rule could not be successfully installed or | ADC |
| | enforced because the Application Identifier is invalid, unknown, or | |
| | not applicable to the application required for detection. | |
| NO_QOS_FLOW_BOUND | Indicates that there is no QoS flow to which the SMF can bind the | |
| | PCC rule. | |
| FILTER_RES | Indicates that the Flow Information within the “flowinfos” attribute | |
| | cannot be handled by the NF service consumer because at least | |
| | one of the restrictions defined in clause 5.4.2 of | |
| | 3GPP TS 29.212 [23] was not respected. | |
| MISS_REDI_SER_ADDR | Indicates that the PCC rule could not be successfully installed or | ADC |
| | enforced at the NF service consumer because there is no valid | |
| | Redirect Server Address within the provided Traffic Control Data | |
| | policy decision to which the PCC rule refers, and no preconfigured | |
| | redirection address for this PCC rule at the SMF/UPF. | |
| CM_END_USER_SER_{—} | Indicates that the charging system denied the service request due | |
| DENIED | to service restrictions (e.g. terminate rating group) or limitations | |
| | related to the end-user, e.g. the end-user's account could not | |
| | cover the requested service. | |
| CM_CREDIT_CON_NOT_{—} | Indicates that the charging system determined that the service | |
| APP | can be granted to the end user but no further credit control is | |
| | needed for the service (e.g. service is free of charge or is treated | |
| | via offline charging). | |
| CM_AUTH_REJ | Indicates that the charging system denied the service request in | |
| | order to terminate the service for which credit is requested. | |
| CM_USER_UNK | Indicates that the specified end user could not be found in the | |
| | charging system. | |
| CM_RAT_FAILED | Indicates that the charging system cannot rate the service request | |
| | due to insufficient rating inputs, incorrect combination of inputs or | |
| | due to an attribute or an attribute value that is not recognized or | |
| | supported in the rating. | |
| UE_STA_SUSP | Indicates that the UE is in suspend state. Only applicable to the | PolicyUpdateWhenUESuspends |
| | interworking scenario, as defined in Annex B. | |
| UNKNOWN_REF_ID | Indicates that the PCC rule could not be successfully | |
| | installed/modified because the referenced identifier to a Policy | |
| | Decision Data or to a Condition Data is unknown to the NF service | |
| | consumer. | |
| INCORRECT_COND_DATA | Indicates that the PCC rule could not be successfully | |
| | installed/modified because the referenced Condition data are | |
| | incorrect (e.g. the “deactivationTime” and the “activationTime” | |
| | included in the referenced ConditionData contain the same time | |
| | value). | |
| REF_ID_COLLISION | Indicates that the PCC rule could not be successfully | |
| | installed/modified because a Policy Decision referenced within the | |
| | PCC rule is also referenced by a session rule (e.g. a session rule | |
| | and this PCC rule refer to the same Usage Monitoring decision | |
| | data). | |
| TRAFFIC_STEERING_{—} | This value is used to indicate that: | |
| ERROR | the enforcement of the steering of traffic to the N6-LAN or | |
| | 5G-LAN failed; or | |
| | the dynamic PCC rule could not be successfully | |
| | installed/modified at the NF service consumer because e.g. there | |
| | are invalid traffic steering policy identifier(s) within the provided | |
| | Traffic Control Data policy decision to which the PCC rule refers. | |
| | Applicable when the functionality introduced with the TSC feature | |
| | described in clause 5.8 applies. | |
| DNAI_STEERING_ERROR | This value is used to indicate that: | |
| | the enforcement of the steering of traffic to the indicated | |
| | DNAI failed; or | |
| | the dynamic PCC rule could not be successfully | |
| | installed/modified at the NF service consumer because there is | |
| | invalid route information for a DNAI(s) (e.g. routing profile id is not | |
| | configured) within the provided Traffic Control Data policy decision | |
| | to which the PCC rule refers. | |
| | Applicable when the functionality introduced with the TSC feature | |
| | described in clause 5.8 applies. | |
| AN_GW_FAILED | Indicates that the AN-Gateway has failed and that the PCF should | SGWRest |
| | refrain from sending policy decisions to the SMF until it is informed | |
| | that the S-GW has been recovered. This value shall not be used if | |
| | the SM Policy association modification procedure is initiated for | |
| | session rule removal only. | |
| MAX_NR_PACKET_{—} | This value is used to indicate that the PCC rule could not be | |
| FILTERS_EXCEEDED | successfully installed, modified or enforced at the NF service | |
| | consumer because the number of supported packet filters for | |
| | signalled QoS rules for the PDU session has been reached. | |
| PACKET_FILTER_TFT_{—} | Indicates that the PCC rule is removed at 5GS to EPS mobility | PackFiltAllocPrecedence |
| ALLOCATION_EXCEEDED | because TFT allocation was not possible since the number of | |
| | active packet filters in the EPC bearer is exceeded. | |
| MUTE_CHG_NOT_{—} | Indicates that the PCC rule could not be successfully modified | |
| ALLOWED | because the mute condition for application detection report cannot | |
| | be changed. | |
| | Applicable when the functionality introduced with the ADC feature | |
| | described in clause 5.8 applies. | |
| UE_TEMPORARILY_{—} | Indicates that the PCC rule could not be successfully | UEUnreachable |
| UNAVAILABLE | installed/modified because the SMF was informed that the UE is | |
| | not reachable. | |

In an example, the feature negotiation over the Npcf_SMPolicyControl API may be defined as in the table 3.

TABLE 3
Supported Features

| Feature number | Feature Name | Description |
|---|---|---|
| 1 | TSC | This feature indicates support for traffic steering control in |
| | | the (S)Gi-LAN, steering the 5G-LAN type of services or |
| | | routing of the user traffic to a local Data Network identified |
| | | by the DNAI per AF request. If the NF service consumer |
| | | supports this feature, the PCF shall behave as described |
| | | in clause 4.2.6.2.6. |
| 2 | ResShare | This feature indicates the support of service data flows |
| | | that share resources. If the NF service consumer supports |
| | | this feature, the PCF shall behave as described in |
| | | clause 4.2.6.2.8. |
| 3 | 3GPP-PS-Data-Off | This feature indicates the support of 3GPP PS Data off |
| | | status change reporting. |
| 4 | ADC | This feature indicates the support of application detection |
| | | and control. |
| 5 | UMC | Indicates that the usage monitoring control is supported. |
| 6 | NetLoc | This feature indicates the support of the Access Network |
| | | Information Reporting for 5GS. |
| 7 | RAN-NAS-Cause | This feature indicates the support for the detailed release |
| | | cause code information from the access network. |
| | | (NOTE) |
| 8 | ProvAFsignalFlow | This feature indicates support for the feature of IMS |
| | | Restoration as described in clause 4.2.3.17. If NF service |
| | | consumer supports this feature the PCF may provision AF |
| | | signalling IP flow information. |
| 9 | PCSCF-Restoration-Enhancement | This feature indicates support of P-CSCF Restoration |
| | | Enhancement. It is used for the NF service consumer to |
| | | indicate if it supports P-CSCF Restoration Enhancement. |
| 10 | PRA | This feature indicates the support of presence reporting |
| | | area change reporting. The support of the update of a UE |
| | | Dedicated Presence Reporting Area is unspecified. |
| 11 | RuleVersioning | This feature indicates the support of PCC rule versioning |
| | | as defined in clause 4.2.6.7. |
| 12 | SponsoredConnectivity | This feature indicates support for sponsored data |
| | | connectivity feature. If the NF service consumer supports |
| | | this feature, the PCF may authorize sponsored data |
| | | connectivity to the subscriber. |
| 13 | RAN-Support-Info | This feature indicates the support of maximum packet loss |
| | | rate value(s) for uplink and/or downlink voice service data |
| | | flow(s). |
| 14 | PolicyUpdateWhenUESuspends | This feature indicates the support of report when the UE is |
| | | suspended and then resumed from suspend state. Only |
| | | applicable to the interworking scenario as defined in |
| | | Annex B. |
| 15 | AccessTypeCondition | This feature indicates the support of access type |
| | | conditioned authorized Session-AMBR as defined in |
| | | clause 4.2.6.3.2.4. |
| 16 | MultiIpv6AddrPrefix | This feature indicates the support of multiple Ipv6 address |
| | | prefixes reporting. |
| 17 | SessionRuleErrorHandling | This feature indicates the support of session rule error |
| | | handling. |
| 18 | AF_Charging_Identifier | This feature indicates the support of long character strings |
| | | as charging identifiers. |
| 19 | ATSSS | This feature indicates the support of the access traffic |
| | | switching, steering and splitting functionality as defined in |
| | | clauses 4.2.6.2.17 and 4.2.6.3.4. |
| 20 | PendingTransaction | This feature indicates support for the race condition |
| | | handling as defined in 3GPP TS 29.513 [7]. |
| 21 | URLLC | This feature indicates support of Ultra-Reliable |
| | | Low-Latency Communication (URLLC) requirements, i.e. |
| | | AF application relocation acknowledgement requirement |
| | | and UE address(es) preservation. The TSC feature shall |
| | | be supported in order to support this feature. |
| 22 | MacAddressRange | Indicates the support of a set of MAC addresses with a |
| | | specific range in the traffic filter. |
| 23 | WWC | Indicates support of wireless and wireline convergence |
| | | access as defined in annex C. |
| 24 | QosMonitoring | Indicates support of QoS monitoring as defined in |
| | | clause 4.2.3.25 and 4.2.4.24. |
| 25 | AuthorizationWithRequiredQoS | Indicates support of policy authorization for the AF session |
| | | with required QoS as defined in clause 4.2.3.22. |
| 26 | EnhancedBackgroundDataTransfer | Indicates the support of applying the Background Data |
| | | Transfer Policy to a future PDU session. |
| 27 | DN-Authorization | This feature indicates the support of DN-AAA authorization |
| | | data for policy control. |
| 28 | PDUSessionRelCause | Indicates the support of “PS_TO_CS_HO” PDU session |
| | | release cause. |
| 29 | SamePcf | This feature indicates the support of same PCF selection |
| | | for the parameter's combination. |
| 30 | ADCmultiRedirection | This feature indicates support for multiple redirection |
| | | information in application detection and control. It requires |
| | | the support of ADC feature. |
| 31 | RespBasedSessionRel | Indicates support of handling PDU session termination |
| | | functionality as defined in clause 4.2.4.22. |
| 32 | TimeSensitiveNetworking | Indicates that the 5G System is integrated within the |
| | | external network as a TSN bridge. |
| 33 | EMDBV | This feature indicates the support of the |
| | | ExtMaxDataBurstVol data type defined in |
| | | 3GPP TS 29.571 [11]. The use of this data type is |
| | | specified in clause 4.2.2.1. |
| 34 | DNNSelectionMode | This feature indicates the support of DNN selection mode. |
| 35 | EPSFallbackReport | This feature indicates the support of the report of EPS |
| | | Fallback as defined in clauses B.3.3.2 and B.3.4.6. |
| 36 | PolicyDecisionErrorHandling | This feature indicates the support of the error report of the |
| | | policy decision and/or condition data which is not referred |
| | | by any PCC rule or session rule as defined in |
| | | clause 4.2.3.26 and 4.2.4.26. |
| 37 | DDNEventPolicyControl | This feature indicates the support for policy control in the |
| | | case of DDN Failure and Delivery Status events as |
| | | defined in clause 4.2.4.27. |
| 38 | ReallocationOfCredit | This feature indicates the support of notifications of |
| | | reallocation of credit. |
| 39 | BDTPolicyRenegotiation | This feature indicates the support of the BDT policy |
| | | re-negotiation. |
| 40 | ExtPolicyDecisionErrorHandling | This feature indicates the support of the error report of a |
| | | faulty SM policy decision parameter as defined in |
| | | clause 4.2.3.26 and 4.2.4.26. It requires the support of |
| | | PolicyDecisionErrorHandling feature. |
| 41 | ImmediateTermination | This feature indicates the support of the termination the |
| | | PDU session when the NF service consumer cannot |
| | | ensure the UE, RAN, AMF, or UPF can revert to the status |
| | | before the PDU session modification occurred, as defined |
| | | in clause 4.2.4.21. |
| 42 | AggregatedUELocChanges | This feature indicates the support of notifications of |
| | | serving area (i.e. tracking area) and/or serving cell |
| | | changes. |
| 43 | ES3XX | Extended Support for 3xx redirections. This feature |
| | | indicates the support of redirection for any service |
| | | operation, according to Stateless NF procedures as |
| | | specified in clauses 6.5.3.2 and 6.5.3.3 of |
| | | 3GPP TS 29.500 [4] and according to HTTP redirection |
| | | principles for indirect communication, as specified in |
| | | clause 6.10.9 of 3GPP TS 29.500 [4]. |
| 44 | GroupIdListChange | This feature indicates the support for the notification of |
| | | changes in the list of internal group identifiers. |
| 45 | DisableUENotification | Indicates the support of disabling QoS flow parameters |
| | | signalling to the UE when the SMF is notified by the |
| | | NG-RAN of changes in the fulfilled QoS situation. This |
| | | feature requires that the AuthorizationWithRequiredQoS |
| | | featute is also supported. |
| 46 | OfflineChOnly | This feature enables the PCF to signal the “PDU Session |
| | | with offline charging only” indication as defined in |
| | | clause 4.2.2.3.3. |
| 47 | Dual-Connectivity-redundant-UP-paths | Indicates the support of policy authorization of end to end |
| | | redundant user plane path using dual connectivity as |
| | | described in clause 4.2.2.20. |
| 48 | DDNEventPolicyControl2 | This feature indicates the support for the policy control |
| | | removal in the case of DDN Failure and/or Delivery Status |
| | | event(s) is cancelled as defined in clause 4.2.4.27. The |
| | | DDNEventPolicyControl feature shall be supported in |
| | | order to support this feature. |
| 49 | VPLMN-QoS-Control | Indicates the support of QoS constraints from the VPLMN |
| | | for the derivation of the authorized Session-AMBR and |
| | | authorized default QoS. |
| 50 | 2G3GIWK | This feature indicates the support of GERAN and UTRAN |
| | | access over N7 interface. |
| 51 | TimeSensitiveCommunication | Indicates that the 5G System is integrated within the |
| | | external network as a TSC user plane node to enable the |
| | | Time Sensitive Communications and Time |
| | | Synchronization. This feature requires that the |
| | | TimeSensitiveNetworking feature is also supported. |
| 52 | AF_latency | This feature indicates the support of Edge relocation |
| | | considering user plane latency. This feature requires that |
| | | the TSC feature is also supported. |
| 53 | SatBackhaulCategoryChg | This feature indicates the support of notification of a |
| | | change between different satellite backhaul categories, or |
| | | between satellite backhaul and non-satellite backhaul. |
| 54 | CHFsetSupport | Indicates the support of CHF redundancy and failover |
| | | mechanisms based on CHF instance availability within a |
| | | CHF Set, as described in clause 4.2.2.3.1. |
| 55 | EnATSSS | Indicates the support of ATSSS enhancement. It requires |
| | | the support of ATSSS feature. |
| 56 | MPSforDTS | Indicates support of the MPSfor DTS feature as described |
| | | in clause 4.2.6.2.12.4. |
| 57 | RoutingInfoRemoval | Indicates the support of the removal of the “routeToLocs” |
| | | attribute from the TrafficControlData instance. |
| 58 | ePRA | This feature indicates the support of presence reporting |
| | | area change reporting. It additionally supports the update |
| | | of the elements of a UE Dedicated Presence Reporting |
| | | Area by the full replacement of the previously provided |
| | | one comparing with the PRA feature. |
| 59 | AMInfluence | Indicates the support of the delivery of the PCF for the UE |
| | | request to be notified by the PCF for the PDU session |
| | | about PDU session established/terminated events. |
| 60 | PvsSupport | This feature indicates the support of SNPN UE Remote |
| | | Provisioning via User Plane as described in |
| | | clause 4.2.2.21. |
| 61 | EneNA | This feature indicates the support of NWDAF data |
| | | reporting. |
| 62 | BIUMR | This feature bit indicates whether the NF Service |
| | | Consumer (e.g. SMF) and PCF supports Binding |
| | | Indication Update for multiple resource contexts specified |
| | | in clauses 6.12.1 and 5.2.3.2.6 of 3GPP TS 29.500 [4]. |
| 63 | EASIPreplacement | This feature indicates the support of EAS IP replacement. |
| | | This feature requires that the TSC feature is also |
| | | supported. |
| 64 | ExposureToEAS | This feature indicates the support of exposure of QoS |
| | | monitoring results to local AF. This feature requires that |
| | | QosMonitoring feature is also supported. |
| 65 | SimultConnectivity | This feature indicates the support of temporary |
| | | simultaneously connectivity at edge relocation. This |
| | | feature requires that the TSC feature is also supported. |
| 66 | SGWRest | This feature indicates the support of SGW Restoration |
| | | procedures. Only applicable to the interworking scenario |
| | | as defined in Annex B. |
| 67 | ReleaseToReactivate | This feature indicates that the PCF can request the SMF |
| | | for reactivation of a PDU session based on an SM Policy |
| | | Association release cause. |
| 68 | EASDiscovery | This feature indicates the support of EAS (re)discovery. |
| 69 | AccNetChargId_String | This feature indicates the support of long character strings |
| | | as access network charging identifier. |
| 70 | WLAN_Location | This feature indicates the support of the report of the |
| | | WLAN location information received from the ePDG/EPC, |
| | | if available. It is only applicable to EPS interworking |
| | | scenarios as specified in Annex B. |
| 71 | PackFiltAllocPrecedence | This feature indicates the support of the control of the |
| | | maximum number of packet filters in the EPS network in |
| | | the EPS interworking scenarios as described in Annex B. |
| 72 | UEUnreachable | This feature indicates the support for the reporting of UE |
| | | temporarily unavailable. |

NOTE:
5GS and EPS release cause code information is supported. The EPS release cause code information from the access network is only applicable to EPS interworking scenarios as specified in Annex B.

In an example, the event reporting in step 9 may include the parameters in the table 4.

TABLE 4
Definition of type AfEventNotification

| Attribute name | Data type | P | Cardinality | Description | Applicability |
|---|---|---|---|---|---|
| event | AfEvent | M | 1 | Notified Event. | |
| flows | array(Flows) | O | 1 . . . N | Affected Service Data Flows. | |
| retryAfter | Uinteger | | | Indicates the estimate on how long it | UEUnreachable |
| | | | | will take before it can be considered the | |
| | | | | paging procedure as completed. It may | |
| | | | | be provided when the event attribute | |
| | | | | indicates | |
| | | | | UE_TEMPORARILY_UNAVAILABLE | |

In an example, the event reporting in step 9 may include the parameters in the table 5.

TABLE 5
Enumeration AfEvent

| Enumeration value | Description | Applicability |
|---|---|---|
| ACCESS_TYPE_CHANGE | Access type change. | |
| ANI_REPORT | Access Network Information Report requested. | NetLoc |
| APP_DETECTION | Application detection report is requested. | ApplicationDetectionEvents |
| CHARGING_CORRELATION | Access Network Charging Correlation Information. | IMS_SBI |
| UP_PATH_CHG_FAILURE | Indicates that the enforcement of the AF required routing | RoutingReqOutcome |
| | requirements (i.e. DNAI change) failed. | |
| EPS_FALLBACK | Indicates that the establishment of the QoS flow for the | EPSFallbackReport |
| | requested voice media type was rejected due to fallback to | |
| | EPS. | |
| FAILED_QOS_UPDATE | Indicates that the invocation/revocation indication included in | MPSforDTS |
| | the mpsAction requested by the NF service consumer has | |
| | failed. | |
| FAILED_RESOURCES_{—} | Indicates that one or more of the SDFs of an Individual | |
| ALLOCATION | Application Session Context are deactivated at the SMF. It also | |
| | indicates that the resources requested for a particular service | |
| | information cannot be successfully allocated. | |
| OUT_OF_CREDIT | Out of credit. | IMS_SBI |
| PDU_SESSION_STATUS | Indicates the status of the PDU session | |
| | (established/terminated). It only applies to notifications to the | |
| | PCF for a UE as specified in clause 4.2.5.22. | |
| PLMN_CHG | This trigger indicates PLMN change. | |
| QOS_NOTIF | The GBR QoS targets of a SDF are not guaranteed or are | |
| | guaranteed again. | |
| QOS_MONITORING | Indicates PCF to enable Qos Monitoring for the Service Data | QoSMonitoring |
| | Flow. | |
| RAN_NAS_CAUSE | This trigger indicates RAN-NAS release cause information is | RAN-NAS-Cause |
| | available in the PCF from the SMF. | |
| | This event does not require explicit subscription. | |
| REALLOCATION_OF_CREDIT | Credit has been reallocated after a former out of credit | IMS_SBI, |
| | indication. | ReallocationOfCredit |
| SAT_CATEGORY_CHG | Indicates that the SMF has detected a change between | SatelliteBackhaul |
| | different satellite backhaul category, or non-satellite backhaul. | |
| SUCCESSFUL_QOS_UPDATE | Indicates that the invocation/revocation indication included in | MPSforDTS |
| | the mpsAction requested by the NF service consumer has been | |
| | successful. | |
| SUCCESSFUL_RESOURCES_{—} | Indicates that the resources requested for particular service | |
| ALLOCATION | information have been successfully allocated. | |
| TSN_BRIDGE_INFO | 5GS Bridge information (UMIC and/or PMIC(s)) received by the | TimeSensitiveNetworking |
| | PCF from the SMF. | |
| USAGE_REPORT | Volume and/or time usage for sponsored data connectivity. | SponsoredConnectivity |
| UE_TEMPORARILY_{—} | UE is not reachable. | UEUnreachable |
| UNAVAILABLE | | |

In an example, the feature negotiation for event reporting in step 9 may include the features in the table 6.

TABLE 6
Supported Features

| Feature | | |
|---|---|---|
| number | Feature Name | Description |
| 1 | InfluenceOnTrafficRouting | Indicates support of Application Function influence on traffic |
| | | routing. If the PCF supports this feature, the NF service consumer |
| | | may influence SMF routing to applications or subscribe to |
| | | notifications of UP path management for the traffic flows of an |
| | | active PDU session. |
| 2 | SponsoredConnectivity | Indicates support of sponsored data connectivity. If the PCF |
| | | supports this feature, the NF service consumer may provide |
| | | sponsored data connectivity to the SUPI. |
| 3 | MediaComponentVersioning | Indicates the support of the media component versioning. |
| 4 | URLLC | Indicates support of Ultra-Reliable Low-Latency Communication |
| | | (URLLC) requirements, i.e. AF application relocation |
| | | acknowledgement and UE address(es) preservation. The |
| | | InfluenceOnTrafficRouting feature shall be supported in order to |
| | | support this feature. |
| 5 | IMS_SBI | Indicates support of the communication with the 5GC IMS NF |
| | | service consumer via Service Based Interfaces. |
| 6 | NetLoc | Indicates the support of access network information reporting. |
| 7 | ProvAFsignalFlow | This indicates support for the feature of provisioning of AF |
| | | signalling flow information as described in clauses 4.2.2.16 and |
| | | 4.2.3.17. If the PCF supports this feature the NF service consumer |
| | | may provision AF signalling flow information. |
| | | NOTE: This feature is used by the IMS Restoration Procedures |
| | | to provide to the SMF the address of the P-CSCF selected by the |
| | | UE, refer to 3GPP TS 23.380 [39]. |
| | | The IMS_SBI feature shall be supported in order to support this |
| | | feature. |
| 8 | ResourceSharing | This feature indicates the support of resource sharing across |
| | | several “Individual Application Session Context” resources. The |
| | | IMS_SBI feature shall be supported in order to support this feature. |
| 9 | MCPTT | This feature indicates the support of Mission Critical Push To Talk |
| | | services as described in 3GPP TS 24.379 [41]. |
| 10 | MCVideo | This feature indicates the support of Mission Critical Video services |
| | | as described in 3GPP TS 24.281 [43]. |
| 11 | PrioritySharing | This feature indicates that Priority Sharing is supported as |
| | | described in 3GPP TS 23.503 [4], clause 6.1.3.15. |
| 12 | MCPTT-Preemption | This feature indicates the support of service pre-emption based on |
| | | the information provided by the NF service consumer. It requires |
| | | that both PrioritySharing and MCPTT features are also supported. |
| 13 | MacAddressRange | Indicates the support of a set of MAC addresses with a specific |
| | | range in the traffic filter. |
| 14 | RAN-NAS-Cause | This feature indicates the support for the release cause code |
| | | information from the access network. |
| 15 | EnhancedSubscriptionToNotification | Indicates the support of: |
| | | Subscription to periodic notifications. |
| | | Definition of a waiting time between the reporting of two event |
| | | triggered events. |
| | | Indication of whether the event has to be reported at PDU |
| | | Session termination. |
| | | Notification Correlation Id for a subscription to an event. |
| 16 | QoSMonitoring | Indicates the support of QoS monitoring information. This feature |
| | | requires the support of the EnhancedSubscriptionToNotification |
| | | feature. |
| 17 | AuthorizationWithRequiredQoS | Indicates support of policy authorization for the AF session with |
| | | required QoS. |
| 18 | TimeSensitiveNetworking | Indicates that the 5G System is integrated within the external |
| | | network as a TSN bridge. |
| 19 | PCSCF-Restoration-Enhancement | This feature indicates support of P-CSCF Restoration |
| | | Enhancement. It is used for the PCF and the P-CSCF to indicate if |
| | | they support P-CSCF Restoration Enhancement. |
| 20 | CHEM | This feature indicates the support of Coverage and Handover |
| | | Enhancements for Media (CHEM). |
| 21 | FLUS | This feature indicates the support of FLUS functionality as |
| | | described in 3GPP TS 26.238 [51]. |
| 22 | EPSFallbackReport | This feature indicates the support of the report of EPS Fallback as |
| | | defined in clauses 4.2.2.30, 4.2.3.29 and 4.2.5.15. |
| 23 | ATSSS | Indicates the support of the report of the multiple access types of a |
| | | MA PDU session. |
| 24 | QoSHint | This feature indicates the support of specific QoS hint parameters |
| | | as described in 3GPP TS 26.114 [30], clause 6.2.10. |
| 25 | ReallocationOfCredit | This feature indicates the support of notifications of reallocation of |
| | | credits events. It requires the support of IMS_SBI feature. |
| 26 | ES3XX | Extended Support for 3xx redirections. This feature indicates the |
| | | support of redirection for any service operation, according to |
| | | Stateless NF procedures as specified in clauses 6.5.3.2 and |
| | | 6.5.3.3 of 3GPP TS 29.500 [5] and according to HTTP redirection |
| | | principles for indirect communication, as specified in clause 6.10.9 |
| | | of 3GPP TS 29.500 [5]. |
| 27 | DisableUENotification | Indicates the support of disabling QoS flow parameters signalling |
| | | to the UE when the SMF is notified by the NG-RAN of changes in |
| | | the fulfilled QoS situation. This feature requires that the |
| | | AuthorizationWithRequiredQoS featute is also supported. |
| 28 | PatchCorrection | Indicates support of the correction to the PATCH method: |
| | | When this feature is not supported, the interoperability between a |
| | | NF service consumer and the PCF can only be ensured when it is |
| | | not required the update of the Individual Application Session |
| | | Context resource. |
| 29 | MPSforDTS | Indicates support for MPS for DTS as described in clauses |
| | | 4.2.2.12.2 and 4.2.3.12. |
| 30 | ApplicationDetectionEvents | This feature indicates the support of the subscription to |
| | | notifications of the detection of the start and stop of an |
| | | application's traffic. |
| 31 | TimeSensitiveCommunication | Indicates that the 5G System is integrated within the external |
| | | network as a TSC user plane node to enable the Time Sensitive |
| | | Communications and Time Synchronization. This feature requires |
| | | that the TimeSensitiveNetworking feature is also supported. |
| 32 | ExposureToEAS | This feature indicates the support of the indication of direct event |
| | | notification of QoS monitoring events from the UPF to the Local |
| | | NEF or AF in 5GC. This indication requires that the QoSMonitoring |
| | | feature is supported. |
| 33 | SatelliteBackhaul | Indicates the support of the report of the satellite or non-satellite |
| | | backhaul category of the PDU session. |
| 34 | RoutingReqOutcome | Indicates the support of: |
| | | the report of UP path change failures; and |
| | | the indication of whether AF routing requirements are |
| | | applied. |
| | | It requires the support of InfluenceOnTrafficRouting feature. |
| 35 | EASDiscovery | This feature indicates the support of EAS (re)discovery. |
| 36 | AltSerReqsWithIndQoS | Indicates the support of provisioning Alternative Service |
| | | Requirements with individual QoS parameters. This feature |
| | | requires that the AuthorizationWithRequiredQoS feature is also |
| | | supported. |
| 37 | SimultConnectivity | This feature indicates the support of the indication of temporary |
| | | simultaneous connectivity over source and target PSA at edge |
| | | relocation. This indication requires that the |
| | | InfluenceOnTrafficRouting feature is supported. |
| 38 | EASIPreplacement | This feature indicates the support of provisioning of EAS IP |
| | | replacement info. This support requires that |
| | | InfluenceOnTrafficRouting feature is also supported |
| 39 | AccNetChargId_String | This feature indicates the support of long character strings as |
| | | access network charging identifier. |
| 40 | WLAN_Location | This feature indicates the support of the report of the WLAN |
| | | location information received from the ePDG/EPC, if available. It is |
| | | only applicable to EPS interworking scenarios as described in |
| | | 3GPP TS 29.512 [8], Annex B. |
| 41 | AF_latency | This feature indicates support for edge relocation considering user |
| | | plane latency. |
| 42 | UEUnreachable | This feature indicates the support for the reporting of UE not |
| | | reachable. |

Step 10. The PCF 103 may answer with a Npcf_SMPolicyControl_Update response.
Step 11. The SMF 103 may send the UPF session release or modification procedure to roll back the new or modified QoS Flow(s), if the N4 rules were setup or modified in step 3.
Step 12. The NF (such as AF) 104 may start the retry-after timer.
Step 13. The AF 104 may retry the provisioning of application/service information to the PCF 103 after the timer is timeout.
Step 14. When the timer has expired, the PCF 103 may send the SM policy association modification procedure about the installation, re-installation, modification or removal of PCC rules to the SMF 102. The PCF 103 may still install PCC rules that do not generate any N1 action (e.g., predefined PCC rules in the default QoS flow) before the expiration.
Step 14a. The PCF 103 may perform a PCF initiated SM policy association modification procedure to notify the SMF 102 about the modifications of policies.
Step 14b. The SMF 102 may acknowledge the notification.

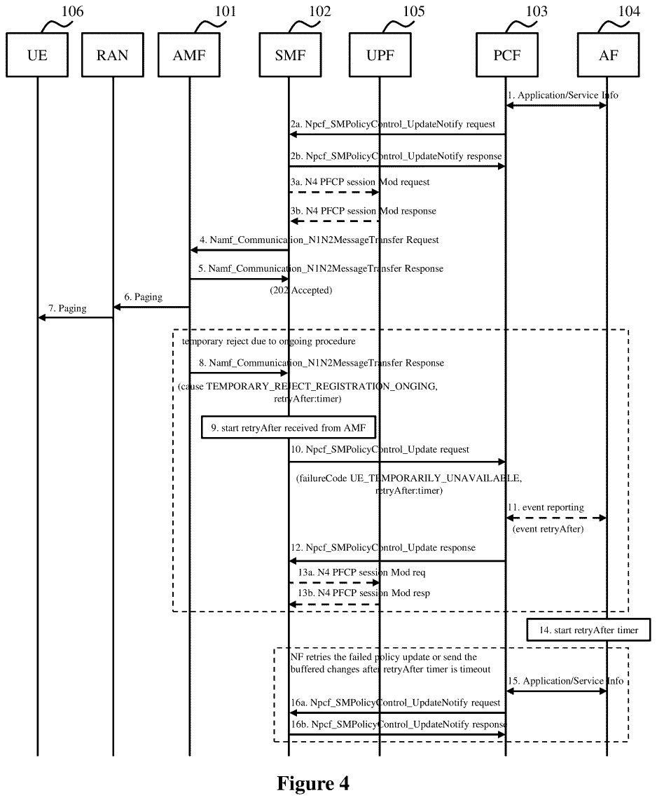

FIG. 4 is a schematic signaling chart showing the messages in another example procedure for improved message suppress sequence flow, according to the embodiments herein. FIG. 4 describes the improved message suppress sequence flow due to temporary rejection for ongoing procedure.

In an embodiment, the procedure for improved message suppress sequence flow in FIG. 4 may include the following messages or steps:
Step 1. The AF 104 may provide the application/service information to the PCF 103 by invoking the Npcf_PolicyAuthorization service.
Step 2. The PCF 103 may make a policy decision. The PCF 103 may determine that updated or new policy information needs to be sent to the SMF 102:
Step 2a. (PCF initiated SM policy association modification). The PCF 103 may perform a PCF initiated SM policy association modification procedure to notify the SMF 102 about the modifications of policies.
Step 2b. The SMF 102 may acknowledge the PCF request with a Npcf_SMPolicyControl_UpdateNotify response.
Step 3. The SMF 102 may initiate the N4 session establishment or modification procedure for new or modified QoS flow(s).
Step 3a. The SMF 102 may update the UPF 105 with N4 Rules related to new or modified QoS flow(s).
Step3b. The UPF(s) 105 may respond to the SMF 102.
Step 4. If the UE 106 is in CM-IDLE state at the AMF 101, and the AMF 101 is able to page the UE 106, the AMF 101 may send a Namf_Communication_N1N2MessageTransfer response to the SMF 102 immediately to indicate to the SMF 102 that the AMF 101 is attempting to reach the UE 106.
Step 5. For SMF requested modification, the SMF 102 may invoke Namf_Communication_N1N2MessageTransfer ([N2 SM information] (PDU session ID, QFI(s), QoS profile(s), [alternative QoS profile(s)], session-AMBR, [CN tunnel info(s)], QoS monitoring indication, QoS monitoring reporting frequency, [TSCAI(s)]), N1 SM container (PDU session modification command (PDU session ID, QoS rule(s), QoS flow level QoS parameters if needed for the QoS flow(s) associated with the QoS rule(s), QoS rule operation and QoS flow level QoS parameters operation, session-AMBR))).
Step 6. The AMF 101 may send a paging message to NG-RAN node(s) via 3GPP access.
Step 7. The NG-RAN may send the paging message to the UE 106.
Step 8. The AMF 101 may notify the SMF 102 by sending Namf_Communications_N1N2MessageTransfer failure notification to the notification target address provided by the SMF 102 in step 2 if the AMF 101 has initiated paging to reach the UE 106 but there is an ongoing registration procedure. The body message may include the failure cause and retry-after timer (a first retry-after time) to request the NF service consumer to stop sending the N1/N2 message before timeout. The other possible procedure is the that AMF 101 may respond with Namf_Communications_N1N2MessageTransfer with 409 status code including cause or “TEMPORARY_REJECT_HANDOVER_ONGOING”) and retry-after in step 5.
Step 9. If the retry-after timer is received, the SMF 102 may start the retry-after timer according to the received timer. Otherwise, the SMF 102 can set a retry-after timer (a second retry-after time) based on local configuration, to suppress sending the N1/N2 message before the retry-after timer is timeout.
Step 10. The SMF 102 may send Npcf_SMPolicyControl_Update request to report the failure of the enforcement of the PCC rule(s), including failure code “UE_TEMPORARILY_UNAVAILABLE” and/or retry-after timer.
Step 11. When an AF 104 has subscribed to an event that is met due to the report (“TEMPORARY_REJECT_REGISTRATION_ONGOING” from the SMF the PCF 102, 103 may report the event “UE_TEMPORARILY_UNAVAILABLE” with retry-after timer (a third retry-after time) to the AF 104 by invoking the Npcf_PolicyAuthorization_Notify service operation.

In an example, a new “retryAfter” attribute is introduced in the “RuleReport” data type for step 10 and/or step 11, so that the AF 104 does not reattempt to provide the application/service information to the PCF 103 or the PCF 103 does not initiate the installation of PCC rule(s) during the AMF-estimated time (the first retry-after time) or the SMF-estimated time (the second retry-after time) that the UE 106 is busy on the other procedure(s).

In addition, when the SMF 102 receives N1N2 transfer failure with “TEMPORARY_REJECT_REGISTRATION_ONGOING” or “TEMPORARY_REJECT_HANDOVER_ONGOING” cause, a new “FailureCode” value, i.e., “UE_TEMPORARILY_UNAVAILABLE” is introduced, to inform the PCF 103 and the AF 104 what's the problem is.

In an example, the steps 10 and/or 11 may also include the parameters as shown in the above table 1 to table 6.
Step 12. The PCF 103 may answer with a Npcf_SMPolicyControl_Update response.
Step 13. The SMF 102 may send the UPF session release or modification procedure to roll back the new or modified QoS flow(s) if the N4 rules were setup or modified in step 3.
Step 14. The NF (such as AF 104) may start the retry-after timer.
Step 15. The AF 104 may retry the provisioning of application/service information to the PCF 103 after the timer is timeout.
Step 16. When the timer has expired, the PCF 103 may send the SM policy association modification procedure about the installation, re-installation, modification or removal of PCC rules to the SMF 102. The PCF 103 may still install PCC rules that do not generate any N1 action (e.g. predefined PCC rules in the default QoS flow) before the expiration.
Step 16a. The PCF 103 may perform a PCF initiated SM policy association modification procedure to notify SMF about the modifications of policies.
Step 16b. The SMF 102 may acknowledge the notification.

The embodiments may allow the PCF 103 and the AF 104 to be aware of what the problem is and when it can reattempt the service or reattempt to change policy information.

The embodiments may prevent the AF 104 and the PCF 103 from reattempting the request until the timer related to paging procedure has expired.

The embodiments may reduce the signal exchange between the PCF 103 and the SMF 102 when the UE 106 is not reachable or the UE 106 is busy on other procedure(s).

The embodiments may reduce paging from the AMF 101 and may save RAN resources.

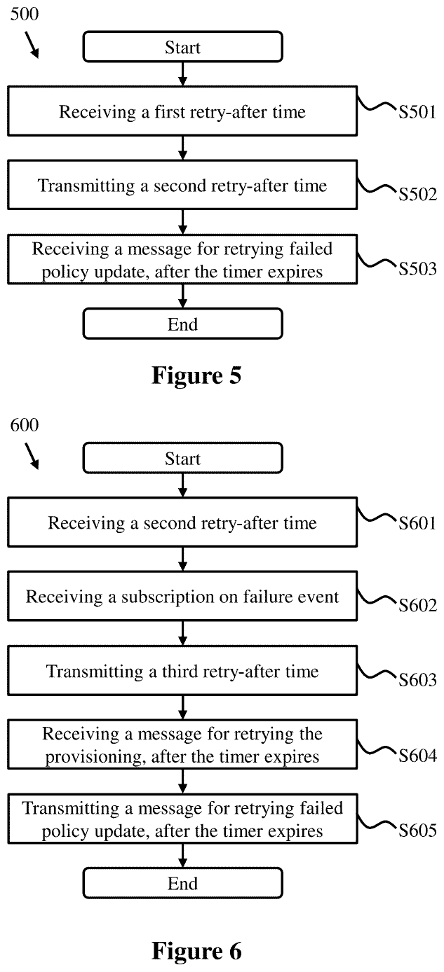

FIG. 5 is a schematic flow chart showing an example method 500 in the second network function (such as the SMF 102), according to the embodiments herein.

The method 500 may begin with step S501, in which the second network function (such as the SMF 102) may receive, from a first network function (such as the AMF 101), a first message including a first parameter indicating a first retry-after time.

In an embodiment, the first retry-after time may indicate the second network function to stop sending a message for a UE (such as the UE 106) before the first retry-after time is timeout. In an embodiment, the first message may further include a fourth parameter indicating a failure cause. In an embodiment, the failure cause may be that the UE is temporarily unavailable.

In an embodiment, the first message may be N1N2 message transfer response message or N1N2 message transfer failure notification message.

Then, the method 500 may proceed to step S502, in which the second network function (such as the SMF 102) may transmit based on the first message, to a third network function (such as the PCT 103), a second message including a second parameter indicating a second retry-after time during which the UE is considered unreachable.

In an embodiment, the second retry-after time may be set based on the first retry-after time.

In an embodiment, the second message may further include a fourth parameter indicating a failure cause. In an embodiment, the failure cause may be that the UE is temporarily unavailable.

In an embodiment, the second message may be a session management policy control update request message.

In an embodiment, the second network function (such as the SMF 102) may further comprise the step of starting a retry-after timer to suppress the transfer of N1 and/or N2 messages.

Then, the method 500 may proceed to step S503, in which the second network function (such as the SMF 102) may receive, from the third network function, a fifth message for retrying the failed policy update or sending the buffered changes, after the retry-after timer expires.

In an embodiment, the fifth message may be a session management policy control update notify request message.

The above steps are only examples, and the second network function (such as the SMF 102) may perform any actions described with respect to FIGS. 2-4, to make the PCF 103 be aware of what the problem is and when it can reattempt the service or reattempt to change policy information.

FIG. 6 is a schematic flow chart showing an example method 600 in the third network function (such as the PCF 103), according to the embodiments herein.

The method 600 may begin with step S601, in which the third network function (such as the PCF 103) may receive, from a second network function (such as the SMF 102), a second message including a second parameter indicating a second retry-after time during which a UE (such as the UE 106) is considered unreachable.

In an embodiment, the second message may further include a fourth parameter indicating a failure cause. In an embodiment, the failure cause may be that the UE is temporarily unavailable.

In an embodiment, the second message may be a session management policy control update request message.

In an embodiment, the third network function (such as the PCF 103) may further comprise the step (not shown) of starting a retry-after timer to suppress the message transfer to the SMF 102.

Then, the method 600 may proceed to step S602, in which the third network function (such as the PCF 103) may receive, from a fourth network function (such as the AF 104), a subscription on a failure event.

Then, the method 600 may proceed to step S603, in which the third network function (such as the PCF 103) may transmit, to the fourth network function (such as the AF 104), a third message including a third parameter indicating a third retry-after time. The third retry-after time may indicate the fourth network function to suppress a transfer of message to the third network function when the third retry-after time runs.

In an embodiment, the third message may be transmitted in response to the failure event.

In an embodiment, the third message may further include a fourth parameter indicating a failure cause. In an embodiment, the failure cause may be that the UE is temporarily unavailable.

In an embodiment, the third message may be an event reporting message.

Then, the method 600 may proceed to step S604, in which the third network function (such as the PCF 103) may receive, from the fourth network function, a fourth message for retrying the provisioning of application or service information, after the retry-after time expires.

In an embodiment, the fourth message may be an application/service information provisioning message.

Then, the method 600 may proceed to step S605, in which the third network function (such as the PCF 103) may transmit, to the second network function (such as the SMF 102), a fifth message for retrying the failed policy update or sending the buffered changes, in response to the fourth message.

In an embodiment, the fifth message may be a session management policy control update notify request message. In an embodiment, the session management policy may be a PCC rule.

The above steps are only examples, and the third network function (such as the PCF 103) may perform any actions described with respect to FIGS. 2-4, to make the AF 104 be aware of what the problem is and when it can reattempt the service or reattempt to change policy information.

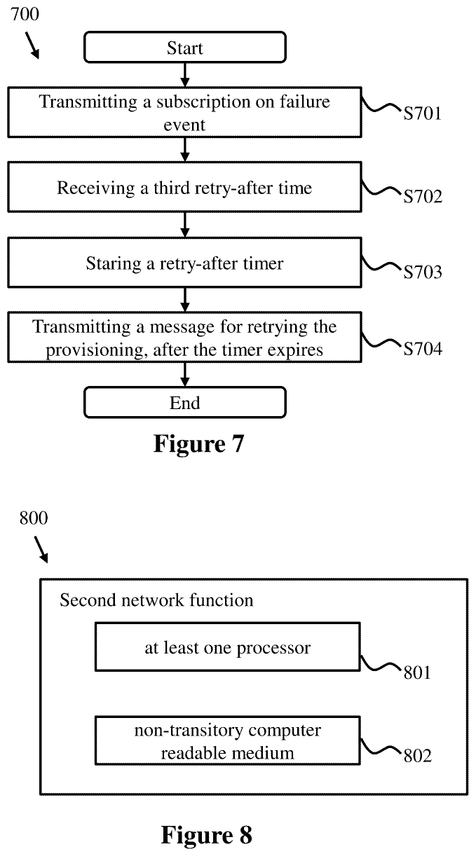

FIG. 7 is a schematic flow chart showing an example method 700 in the fourth network function (such as the AF 104), according to the embodiments herein.

The method 700 may begin with step S701, in which the fourth network function (such as the AF 104) may transmit, to a third network function (such as the PCF 103), a subscription on a failure event.

Then, the method 700 may proceed to step S702, in which the fourth network function (such as the AF 104) may receive, from the third network function, a third message including a third parameter indicating a third retry-after time. The third retry-after time may indicate the fourth network function to suppress a transfer of message to the third network function during the third retry-after time.

In an embodiment, the third message may further include a fourth parameter indicating a failure cause. In an embodiment, the failure cause may be that the UE is temporarily unavailable.

In an embodiment, the third message may be transmitted in response to the failure event.

In an embodiment, the third message may be an event reporting message.

Then, the method 700 may proceed to step S703, in which the fourth network function (such as the AF 104) may start a retry-after timer according to the third parameter, to suppress a transfer of message to the third network function when the retry-after timer runs.

Then, the method 700 may proceed to step S704, in which the fourth network function (such as the AF 104) may transmit, to the third network function, a fourth message for retrying the provisioning of application or service information, after the retry-after timer expires.

In an embodiment, the fifth message may be a session management policy control update notify request message.

In an embodiment, the session management policy may be a PCC rule.

The above steps are only examples, and the fourth network function (such as the AF 104) may perform any actions described with respect to FIGS. 2-4, to make the AF 104 aware of what the problem is and when it can reattempt the service or reattempt to change policy information.

FIG. 8 is a schematic block diagram showing an example second network function 800 (such as the SMF 102), according to the embodiments herein.

In an embodiment, the second network function 800 may include at least one processor 801; and a non-transitory computer readable medium 802 coupled to the at least one processor 801. The non-transitory computer readable medium 802 may store instructions executable by the at least one processor 801, whereby the at least one processor 801 may be configured to perform the steps in the example method 500 as shown in the schematic flow chart of FIG. 5; the details thereof are omitted here.

Note that, the second network function 800 may be implemented as hardware, software, firmware and any combination thereof. For example, the second network function 800 may include a plurality of units, circuities, modules or the like, each of which may be used to perform one or more steps of the example method 500 or one or more steps related to the SMF 102.

It should be understood that, the second network function 800 may be implemented either as a network element on a dedicated hardware, as a software instance running on a dedicated hardware, or as a virtualized function instantiated on an appropriate platform, e.g. on a cloud infrastructure.

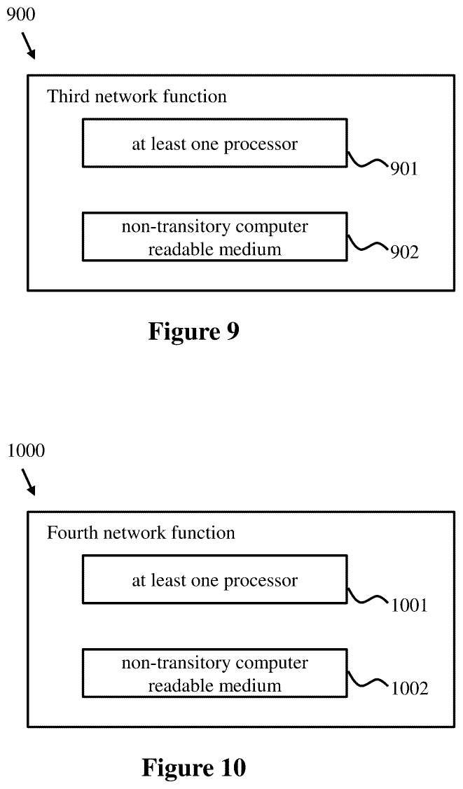

FIG. 9 is a schematic block diagram showing an example third network function 900 (such as the PCF 103), according to the embodiments herein.

In an embodiment, the third network function 900 may include at least one processor 901; and a non-transitory computer readable medium 902 coupled to the at least one processor 901. The non-transitory computer readable medium 902 may store instructions executable by the at least one processor 901, whereby the at least one processor 901 may be configured to perform the steps in the example method 600 as shown in the schematic flow chart of FIG. 6; the details thereof are omitted here.

Note that, the third network function 900 may be implemented as hardware, software, firmware and any combination thereof. For example, the third network function 900 may include a plurality of units, circuities, modules or the like, each of which may be used to perform one or more steps of the example method 600 or one or more steps related to the PCF 103.

It should be understood that, the third network function 900 may be implemented either as a network element on a dedicated hardware, as a software instance running on a dedicated hardware, or as a virtualized function instantiated on an appropriate platform, e.g. on a cloud infrastructure.

FIG. 10 is a schematic block diagram showing an example fourth network function 1000 (such as the AF 104), according to the embodiments herein.

In an embodiment, the fourth network function 1000 may include at least one processor 1001; and a non-transitory computer readable medium 1002 coupled to the at least one processor 1001. The non-transitory computer readable medium 1002 may store instructions executable by the at least one processor 1001, whereby the at least one processor 1001 may be configured to perform the steps in the example method 700 as shown in the schematic flow chart of FIG. 7; the details thereof are omitted here.

Note that, the fourth network function 1000 may be implemented as hardware, software, firmware and any combination thereof. For example, the fourth network function 1000 may include a plurality of units, circuities, modules or the like, each of which may be used to perform one or more steps of the example method 700 or one or more steps related to the AF 104.

It should be understood that, the fourth network function 1000 may be implemented either as a network element on a dedicated hardware, as a software instance running on a dedicated hardware, or as a virtualized function instantiated on an appropriate platform, e.g. on a cloud infrastructure.

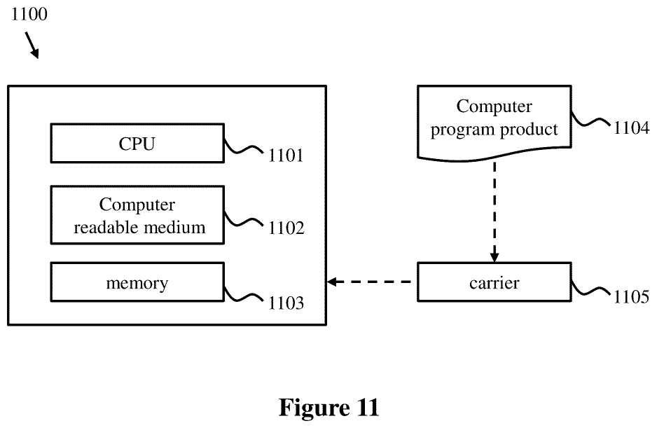

FIG. 11 is a schematic block diagram showing an example computer-implemented apparatus 1100, according to the embodiments herein. In an embodiment, the apparatus 1100 may be configured as the above mentioned apparatus, such as the SMF 102, the PCF 103, the AF 104, the second network function 800, the third network function 900, or the fourth network function 1000.

In an embodiment, the apparatus 1100 may include but not limited to at least one processor such as Central Processing Unit (CPU) 1101, a computer-readable medium 1102, and a memory 1103. The memory 1103 may comprise a volatile (e.g., Random Access Memory, RAM) and/or non-volatile memory (e.g., a hard disk or flash memory). In an embodiment, the computer-readable medium 1102 may be configured to store a computer program and/or instructions, which, when executed by the processor 1101, causes the processor 1101 to carry out any of the above mentioned methods.

In an embodiment, the computer-readable medium 1102 (such as non-transitory computer readable medium) may be stored in the memory 1103. In another embodiment, the computer program may be stored in a remote location for example computer program product 1104 (also may be embodied as computer-readable medium), and accessible by the processor 1101 via for example carrier 1105.

The computer-readable medium 1102 and/or the computer program product 1104 may be distributed and/or stored on a removable computer-readable medium, e.g. diskette, CD (Compact Disk), DVD (Digital Video Disk), flash or similar removable memory media (e.g. compact flash, SD (secure digital), memory stick, mini SD card, MMC multimedia card, smart media), HD-DVD (High Definition DVD), or Blu-ray DVD, USB (Universal Serial Bus) based removable memory media, magnetic tape media, optical storage media, magneto-optical media, bubble memory, or distributed as a propagated signal via a network (e.g. Ethernet, ATM, ISDN, PSTN, X.25, Internet, Local Area Network (LAN), or similar networks capable of transporting data packets to the infrastructure node).

Furthermore, the following amendments are proposed to amend the current 3GPP Technical Specification 3GPP TS29.512 (the underline indicates the changed parts).

### 5.6.2.27 Type RuleReport

TABLE 5.6.2.27-1
Definition of type RuleReport

| Attribute name | Data type | P | Cardinality | Description | Applicability |
|---|---|---|---|---|---|
| pccRuleIds | array(string) | M | 1 . . . N | Contains the identifier(s) of the affected | |
| | | | | PCC rule(s). | |
| ruleStatus | RuleStatus | M | 1 | Indicates the status of the PCC rule(s). | |
| contVers | array(ContentVersion) | C | 1 . . . N | Indicates the version(s) of the PCC | RuleVersioning |
| | | | | rule(s). If the RuleVersioning feature is | |
| | | | | supported, the content version shall be | |
| | | | | included in this attribute if it was | |
| | | | | included when the corresponding PCC | |
| | | | | rule was installed or modified. | |
| failureCode | FailureCode | C | 0 . . . 1 | Indicates the reason why the PCC | |
| | | | | Rule(s) are being reported. It shall be | |
| | | | | included when the NF service | |
| | | | | consumer reports the failure of the | |
| | | | | enforcement of the PCC rule(s). | |
| retryAfter | Uinteger | O | 0 . . . 1 | Indicates the estimate on how long it | UEUnreachable |
| | | | | will take before it can be considered the | |
| | | | | UE is reachable or how long the | |
| | | | | ongoing procedure is completed. | |
| | | | | It may be provided when the | |
| | | | | failureCode attribute indicates | |
| | | | | UE TEMPORARILY UNAVAILABLE. | |
| finUnitAct | FinalUnitAction | O | 0 . . . 1 | Contains the related filter parameters | |
| | | | | and redirect address parameters (if | |
| | | | | available), when the user's account | |
| | | | | cannot cover the service cost. | |
| ranNasRelCauses | array(RanNasRelCause) | O | 1 . . . N | Indicates the RAN or NAS release | RAN-NAS-Cause |
| | | | | cause code information. | |
| altQosParamId | string | O | 0 . . . 1 | Indicates the alternative QoS | AuthorizationWithRequiredQoS |
| | | | | parameter set that the NG-RAN can | |
| | | | | guarantee. It is included during the | |
| | | | | report of success resource allocation | |
| | | | | and indicates that NG-RAN used an | |
| | | | | alternative QoS profile because the | |
| | | | | requested QoS could not be allocated. | |

5.6.3.9 Enumeration: FailureCode

TABLE 5.6.3.9-1
Enumeration FailureCode

| Enumeration value | Description | Applicability |
|---|---|---|
| UNK_RULE_ID | Indicates that the pre-provisioned PCC rule could not be | |
| | successfully activated because the provided PCC rule identifier is | |
| | unknown to the NF service consumer. | |
| RA_GR_ERR | Indicates that the PCC rule could not be successfully installed or | |
| | enforced because the Rating Group specified within the Charging | |
| | Data policy decision to which the PCC rule refers is unknown or | |
| | invalid. | |
| SER_ID_ERR | Indicates that the PCC rule could not be successfully installed or | |
| | enforced because the Service Identifier specified within the | |
| | Charging Data policy decision to which the PCC rule refers is | |
| | invalid, unknown or not applicable to the service being charged. | |
| NF_MAL | Indicates that the PCC rule could not be successfully installed (for | |
| | those provisioned from the PCF), activated (for those pre-defined | |
| | in the SMF) or enforced (for those already successfully installed) | |
| | due to SMF/UPF malfunction. | |
| RES_LIM | Indicates that the PCC rule could not be successfully installed (for | |
| | those provisioned from the PCF), activated (for those pre-defined | |
| | in the SMF) or enforced (for those already successfully installed) | |
| | due to a limitation of resources at the SMF/UPF. | |
| MAX_NR_QoS_FLOW | Indicates that the PCC rule could not be successfully installed (for | |
| | those provisioned from the PCF), activated (for those pre-defined | |
| | in the SMF) or enforced (for those already successfully installed) | |
| | due to the fact that the maximum number of QoS flows has been | |
| | reached for the associated PDU session. | |
| MISS_FLOW_INFO | Indicates that the PCC rule could not be successfully installed | |
| | (for those provisioned from the PCF) or enforced (for those | |
| | already successfully installed) because neither the “flowInfos” | |
| | attribute nor the “appId” attribute is specified by the PCF within the | |
| | PCC rule entry of the “pccRules” attribute during the first PCC rule | |
| | installation request. | |
| RES_ALLO_FAIL | Indicates that the PCC rule could not be successfully installed or | |
| | maintained since the associated QoS flow | |
| | establishment/modification failed or the associated QoS flow was | |
| | released. | |
| UNSUCC_QOS_VAL | This value is used to: | |
| | indicate that QoS validation has failed; or | |
| | indicate when Guaranteed Bandwidth > | |
| | Max-Requested-Bandwidth. | |
| INCOR_FLOW_INFO | Indicates that the PCC rule could not be successfully installed or | |
| | modified at the NF service consumer because the provided flow | |
| | information is not supported by the network (e.g. the provided IP | |
| | address(es) or Ipv6 prefix(es) do not correspond to an IP version | |
| | applicable for the PDU session). | |
| PS_TO_CS_HAN | Indicates that the PCC rule could not be maintained because of | |
| | PS to CS handover. | |
| APP_ID_ERR | Indicates that the PCC rule could not be successfully installed or | ADC |
| | enforced because the Application Identifier is invalid, unknown, or | |
| | not applicable to the application required for detection. | |
| NO_QOS_FLOW_BOUND | Indicates that there is no QoS flow to which the SMF can bind the | |
| | PCC rule. | |
| FILTER_RES | Indicates that the Flow Information within the “flowinfos” attribute | |
| | cannot be handled by the NF service consumer because at least | |
| | one of the restrictions defined in clause 5.4.2 of | |
| | 3GPP TS 29.212 [23] was not respected. | |
| MISS_REDI_SER_ADDR | Indicates that the PCC rule could not be successfully installed or | ADC |
| | enforced at the NF service consumer because there is no valid | |
| | Redirect Server Address within the provided Traffic Control Data | |
| | policy decision to which the PCC rule refers, and no preconfigured | |
| | redirection address for this PCC rule at the SMF/UPF. | |
| CM_END_USER_SER_{—} | Indicates that the charging system denied the service request due | |
| DENIED | to service restrictions (e.g. terminate rating group) or limitations | |
| | related to the end-user, e.g. the end-user's account could not | |
| | cover the requested service. | |
| CM_CREDIT_CON_NOT_{—} | Indicates that the charging system determined that the service | |
| APP | can be granted to the end user but no further credit control is | |
| | needed for the service (e.g. service is free of charge or is treated | |
| | via offline charging). | |
| CM_AUTH_REJ | Indicates that the charging system denied the service request in | |
| | order to terminate the service for which credit is requested. | |
| CM_USER_UNK | Indicates that the specified end user could not be found in the | |
| | charging system. | |
| CM_RAT_FAILED | Indicates that the charging system cannot rate the service request | |
| | due to insufficient rating inputs, incorrect combination of inputs or | |
| | due to an attribute or an attribute value that is not recognized or | |
| | supported in the rating. | |
| UE_STA_SUSP | Indicates that the UE is in suspend state. Only applicable to the | PolicyUpdateWhenUESuspends |
| | interworking scenario, as defined in Annex B. | |
| UNKNOWN_REF_ID | Indicates that the PCC rule could not be successfully | |
| | installed/modified because the referenced identifier to a Policy | |
| | Decision Data or to a Condition Data is unknown to the NF service | |
| | consumer. | |
| INCORRECT_COND_DATA | Indicates that the PCC rule could not be successfully | |
| | installed/modified because the referenced Condition data are | |
| | incorrect (e.g. the “deactivationTime” and the “activationTime” | |
| | included in the referenced ConditionData contain the same time | |
| | value). | |
| REF_ID_COLLISION | Indicates that the PCC rule could not be successfully | |
| | installed/modified because a Policy Decision referenced within the | |
| | PCC rule is also referenced by a session rule (e.g. a session rule | |
| | and this PCC rule refer to the same Usage Monitoring decision | |
| | data) | |
| TRAFFIC_STEERING_{—} | This value is used to indicate that: | |
| ERROR | the enforcement of the steering of traffic to the N6-LAN or | |
| | 5G-LAN failed; or | |
| | the dynamic PCC rule could not be successfully | |
| | installed/modified at the NF service consumer because e.g. there | |
| | are invalid traffic steering policy identifier(s) within the provided | |
| | Traffic Control Data policy decision to which the PCC rule refers. | |
| | Applicable when the functionality introduced with the TSC feature | |
| | described in clause 5.8 applies. | |
| DNAI_STEERING_ERROR | This value is used to indicate that: | |
| | the enforcement of the steering of traffic to the indicated | |
| | DNAI failed; or | |
| | the dynamic PCC rule could not be successfully | |
| | installed/modified at the NF service consumer because there is | |
| | invalid route information for a DNAI(s) (e.g. routing profile id is not | |
| | configured) within the provided Traffic Control Data policy decision | |
| | to which the PCC rule refers. | |
| | Applicable when the functionality introduced with the TSC feature | |
| | described in clause 5.8 applies. | |
| AN_GW_FAILED | Indicates that the AN-Gateway has failed and that the PCF should | SGWRest |
| | refrain from sending policy decisions to the SMF until it is informed | |
| | that the S-GW has been recovered. This value shall not be used if | |
| | the SM Policy association modification procedure is initiated for | |
| | session rule removal only. | |
| MAX_NR_PACKET_{—} | This value is used to indicate that the PCC rule could not be | |
| FILTERS_EXCEEDED | successfully installed, modified or enforced at the NF service | |
| | consumer because the number of supported packet filters for | |
| | signalled QoS rules for the PDU session has been reached. | |
| PACKET_FILTER_TFT_{—} | Indicates that the PCC rule is removed at 5GS to EPS mobility | PackFiltAllocPrecedence |
| ALLOCATION_EXCEEDED | because TFT allocation was not possible since the number of | |
| | active packet filters in the EPC bearer is exceeded. | |
| MUTE_CHG_NOT_{—} | Indicates that the PCC rule could not be successfully modified | |
| ALLOWED | because the mute condition for application detection report cannot | |
| | be changed. | |
| | Applicable when the functionality introduced with the ADC feature | |
| | described in clause 5.8 applies. | |
| UE TEMPORARILY | Indicates that the PCC rule could not be successfully | UEUnreachable |
| UNAVAILABLE | installed/modified because the SMF was informed | |
| | that the UE is not reachable. | |

5.8 Feature negotiation

The optional features in table 5.8-1 are defined for the Npcf_SMPolicyControl API. They shall be negotiated using the extensibility mechanism defined in clause 6.6 of 3GPP TS 29.500 [4].

TABLE 5.8-1
Supported Features

| Feature number | Feature Name | Description |
|---|---|---|
| 1 | TSC | This feature indicates support for traffic steering control in |
| | | the (S)Gi-LAN, steering the 5G-LAN type of services or |
| | | routing of the user traffic to a local Data Network identified |
| | | by the DNAI per AF request. If the NF service consumer |
| | | supports this feature, the PCF shall behave as described |
| | | in clause 4.2.6.2.6. |
| 2 | ResShare | This feature indicates the support of service data flows |
| | | that share resources. If the NF service consumer supports |
| | | this feature, the PCF shall behave as described in |
| | | clause 4.2.6.2.8. |
| 3 | 3GPP-PS-Data-Off | This feature indicates the support of 3GPP PS Data off |
| | | status change reporting. |
| 4 | ADC | This feature indicates the support of application detection |
| | | and control. |
| 5 | UMC | Indicates that the usage monitoring control is supported. |
| 6 | NetLoc | This feature indicates the support of the Access Network |
| | | Information Reporting for 5GS. |
| 7 | RAN-NAS-Cause | This feature indicates the support for the detailed release |
| | | cause code information from the access network. |
| | | (NOTE) |
| 8 | ProvAFsignalFlow | This feature indicates support for the feature of IMS |
| | | Restoration as described in clause 4.2.3.17. If NF service |
| | | consumer supports this feature the PCF may provision AF |
| | | signalling IP flow information. |
| 9 | PCSCF-Restoration-Enhancement | This feature indicates support of P-CSCF Restoration |
| | | Enhancement. It is used for the NF service consumer to |
| | | indicate if it supports P-CSCF Restoration Enhancement. |
| 10 | PRA | This feature indicates the support of presence reporting |
| | | area change reporting. The support of the update of a UE |
| | | Dedicated Presence Reporting Area is unspecified. |
| 11 | RuleVersioning | This feature indicates the support of PCC rule versioning |
| | | as defined in clause 4.2.6.7. |
| 12 | SponsoredConnectivity | This feature indicates support for sponsored data |
| | | connectivity feature. If the NF service consumer supports |
| | | this feature, the PCF may authorize sponsored data |
| | | connectivity to the subscriber. |
| 13 | RAN-Support-Info | This feature indicates the support of maximum packet loss |
| | | rate value(s) for uplink and/or downlink voice service data |
| | | flow(s). |
| 14 | PolicyUpdateWhenUESuspends | This feature indicates the support of report when the UE is |
| | | suspended and then resumed from suspend state. Only |
| | | applicable to the interworking scenario as defined in |
| | | Annex B. |
| 15 | AccessTypeCondition | This feature indicates the support of access type |
| | | conditioned authorized Session-AMBR as defined in |
| | | clause 4.2.6.3.2.4. |
| 16 | MultiIpv6AddrPrefix | This feature indicates the support of multiple Ipv6 address |
| | | prefixes reporting. |
| 17 | SessionRuleErrorHandling | This feature indicates the support of session rule error |
| | | handling. |
| 18 | AF_Charging_Identifier | This feature indicates the support of long character strings |
| | | as charging identifiers. |
| 19 | ATSSS | This feature indicates the support of the access traffic |
| | | switching, steering and splitting functionality as defined in |
| | | clauses 4.2.6.2.17 and 4.2.6.3.4. |
| 20 | PendingTransaction | This feature indicates support for the race condition |
| | | handling as defined in 3GPP TS 29.513 [7]. |
| 21 | URLLC | This feature indicates support of Ultra-Reliable |
| | | Low-Latency Communication (URLLC) requirements, i.e. |
| | | AF application relocation acknowledgement requirement |
| | | and UE address(es) preservation. The TSC feature shall |
| | | be supported in order to support this feature. |
| 22 | MacAddressRange | Indicates the support of a set of MAC addresses with a |
| | | specific range in the traffic filter. |
| 23 | WWC | Indicates support of wireless and wireline convergence |
| | | access as defined in annex C. |
| 24 | QosMonitoring | Indicates support of QoS monitoring as defined in |
| | | clause 4.2.3.25 and 4.2.4.24. |
| 25 | AuthorizationWithRequiredQoS | Indicates support of policy authorization for the AF session |
| | | with required QoS as defined in clause 4.2.3.22. |
| 26 | EnhancedBackgroundDataTransfer | Indicates the support of applying the Background Data |
| | | Transfer Policy to a future PDU session. |
| 27 | DN-Authorization | This feature indicates the support of DN-AAA authorization |
| | | data for policy control. |
| 28 | PDUSessionRelCause | Indicates the support of “PS_TO_CS_HO” PDU session |
| | | release cause. |
| 29 | SamePcf | This feature indicates the support of same PCF selection |
| | | for the parameter's combination. |
| 30 | ADCmultiRedirection | This feature indicates support for multiple redirection |
| | | information in application detection and control. It requires |
| | | the support of ADC feature. |
| 31 | RespBasedSessionRel | Indicates support of handling PDU session termination |
| | | functionality as defined in clause 4.2.4.22. |
| 32 | TimeSensitiveNetworking | Indicates that the 5G System is integrated within the |
| | | external network as a TSN bridge. |
| 33 | EMDBV | This feature indicates the support of the |
| | | ExtMaxDataBurstVol data type defined in |
| | | 3GPP TS 29.571 [11]. The use of this data type is |
| | | specified in clause 4.2.2.1. |
| 34 | DNNSelectionMode | This feature indicates the support of DNN selection mode. |
| 35 | EPSFallbackReport | This feature indicates the support of the report of EPS |
| | | Fallback as defined in clauses B.3.3.2 and B.3.4.6. |
| 36 | PolicyDecisionErrorHandling | This feature indicates the support of the error report of the |
| | | policy decision and/or condition data which is not referred |
| | | by any PCC rule or session rule as defined in |
| | | clause 4.2.3.26 and 4.2.4.26. |
| 37 | DDNEventPolicyControl | This feature indicates the support for policy control in the |
| | | case of DDN Failure and Delivery Status events as |
| | | defined in clause 4.2.4.27. |
| 38 | ReallocationOfCredit | This feature indicates the support of notifications of |
| | | reallocation of credit. |
| 39 | BDTPolicyRenegotiation | This feature indicates the support of the BDT policy |
| | | re-negotiation. |
| 40 | ExtPolicyDecisionErrorHandling | This feature indicates the support of the error report of a |
| | | faulty SM policy decision parameter as defined in |
| | | clause 4.2.3.26 and 4.2.4.26. It requires the support of |
| | | PolicyDecisionErrorHandling feature. |
| 41 | ImmediateTermination | This feature indicates the support of the termination the |
| | | PDU session when the NF service consumer cannot |
| | | ensure the UE, RAN, AMF, or UPF can revert to the status |
| | | before the PDU session modification occurred, as defined |
| | | in clause 4.2.4.21. |
| 42 | AggregatedUELocChanges | This feature indicates the support of notifications of |
| | | serving area (i.e. tracking area) and/or serving cell |
| | | changes. |
| 43 | ES3XX | Extended Support for 3xx redirections. This feature |
| | | indicates the support of redirection for any service |
| | | operation, according to Stateless NF procedures as |
| | | specified in clauses 6.5.3.2 and 6.5.3.3 of |
| | | 3GPP TS 29.500 [4] and according to HTTP redirection |
| | | principles for indirect communication, as specified in |
| | | clause 6.10.9 of 3GPP TS 29.500 [4]. |
| 44 | GroupIdListChange | This feature indicates the support for the notification of |
| | | changes in the list of internal group identifiers. |
| 45 | DisableUENotification | Indicates the support of disabling QoS flow parameters |
| | | signalling to the UE when the SMF is notified by the |
| | | NG-RAN of changes in the fulfilled QoS situation. This |
| | | feature requires that the AuthorizationWithRequiredQoS |
| | | feature is also supported. |
| 46 | OfflineChOnly | This feature enables the PCF to signal the “PDU Session |
| | | with offline charging only” indication as defined in |
| | | clause 4.2.2.3.3. |
| 47 | Dual-Connectivity-redundant-UP-paths | Indicates the support of policy authorization of end to end |
| | | redundant user plane path using dual connectivity as |
| | | described in clause 4.2.2.20. |
| 48 | DDNEventPolicyControl2 | This feature indicates the support for the policy control |
| | | removal in the case of DDN Failure and/or Delivery Status |
| | | event(s) is cancelled as defined in clause 4.2.4.27. The |
| | | DDNEventPolicyControl feature shall be supported in |
| | | order to support this feature. |
| 49 | VPLMN-QoS-Control | Indicates the support of QoS constraints from the VPLMN |
| | | for the derivation of the authorized Session-AMBR and |
| | | authorized default QoS. |
| 50 | 2G3GIWK | This feature indicates the support of GERAN and UTRAN |
| | | access over N7 interface. |
| 51 | TimeSensitiveCommunication | Indicates that the 5G System is integrated within the |
| | | external network as a TSC user plane node to enable the |
| | | Time Sensitive Communications and Time |
| | | Synchronization. This feature requires that the |
| | | TimeSensitiveNetworking feature is also supported. |
| 52 | AF_latency | This feature indicates the support of Edge relocation |
| | | considering user plane latency. This feature requires that |
| | | the TSC feature is also supported. |
| 53 | SatBackhaulCategoryChg | This feature indicates the support of notification of a |
| | | change between different satellite backhaul categories, or |
| | | between satellite backhaul and non-satellite backhaul. |
| 54 | CHFsetSupport | Indicates the support of CHF redundancy and failover |
| | | mechanisms based on CHF instance availability within a |
| | | CHF Set, as described in clause 4.2.2.3.1. |
| 55 | EnATSSS | Indicates the support of ATSSS enhancement. It requires |
| | | the support of ATSSS feature. |
| 56 | MPSforDTS | Indicates support of the MPSfor DTS feature as described |
| | | in clause 4.2.6.2.12.4. |
| 57 | RoutingInfoRemoval | Indicates the support of the removal of the “routeToLocs” |
| | | attribute from the TrafficControlData instance. |
| 58 | ePRA | This feature indicates the support of presence reporting |
| | | area change reporting. It additionally supports the update |
| | | of the elements of a UE Dedicated Presence Reporting |
| | | Area by the full replacement of the previously provided |
| | | one comparing with the PRA feature. |
| 59 | AMInfluence | Indicates the support of the delivery of the PCF for the UE |
| | | request to be notified by the PCF for the PDU session |
| | | about PDU session established/terminated events. |
| 60 | PvsSupport | This feature indicates the support of SNPN UE Remote |
| | | Provisioning via User Plane as described in |
| | | clause 4.2.2.21. |
| 61 | EneNA | This feature indicates the support of NWDAF data |
| | | reporting. |
| 62 | BIUMR | This feature bit indicates whether the NF Service |
| | | Consumer (e.g. SMF) and PCF supports Binding |
| | | Indication Update for multiple resource contexts specified |
| | | in clauses 6.12.1 and 5.2.3.2.6 of 3GPP TS 29.500 [4]. |
| 63 | EASIPreplacement | This feature indicates the support of EAS IP replacement. |
| | | This feature requires that the TSC feature is also |
| | | supported. |
| 64 | ExposureToEAS | This feature indicates the support of exposure of QoS |
| | | monitoring results to local AF. This feature requires that |
| | | QosMonitoring feature is also supported. |
| 65 | SimultConnectivity | This feature indicates the support of temporary |
| | | simultaneously connectivity at edge relocation. This |
| | | feature requires that the TSC feature is also supported. |
| 66 | SGWRest | This feature indicates the support of SGW Restoration |
| | | procedures. Only applicable to the interworking scenario |
| | | as defined in Annex B. |
| 67 | ReleaseToReactivate | This feature indicates that the PCF can request the SMF |
| | | for reactivation of a PDU session based on an SM Policy |
| | | Association release cause. |
| 68 | EASDiscovery | This feature indicates the support of EAS (re)discovery. |
| 69 | AccNetChargId_String | This feature indicates the support of long character strings |
| | | as access network charging identifier. |
| 70 | WLAN_Location | This feature indicates the support of the report of the |
| | | WLAN location information received from the ePDG/EPC, |
| | | if available. It is only applicable to EPS interworking |
| | | scenarios as specified in Annex B. |
| 71 | PackFiltAllocPrecedence | This feature indicates the support of the control of the |
| | | maximum number of packet filters in the EPS network in |
| | | the EPS interworking scenarios as described in Annex B. |
| 72 | UEUnreachable | This feature indicates the support for the |
| | | reporting of UE temporarily unavailable. |

NOTE:
5GS and EPS release cause code information is supported. The EPS release cause code information from the access network is only applicable to EPS interworking scenarios as specified in Annex B.

Furthermore, the following amendments are proposed to amend the current 3GPP Technical Specification 3GPP TS29.514 (the underline indicates the changed parts).

### 4.2.2.10 Subscription to Resources Allocation Outcome

This procedure is used by a NF service consumer to subscribe to notifications when the resources associated to the corresponding service information have been allocated and/or cannot be allocated.

The NF service consumer shall use the “EventsSubscReqData” data type as described in clause 4.2.2.2 and shall include in the HTTP POST request message:
if the NF service consumer requests the PCF to provide a notification when the resources associated to the service information have been allocated, an event entry within the “events” attribute with to set the “event” attribute “SUCCESSFUL_RESOURCES_ALLOCATION”;
if the NF service consumer requests the PCF to provide a notification when the resources associated to the service information cannot be allocated, an event entry within the “events” attribute with the “event” attribute set to “FAILED_RESOURCES_ALLOCATION”; and/or
if the feature “UEUnreachable” is supported and the NF service consumer request the PCF to provide a notification when the resources associated to the service information are not allocated because the UE is unreachable, an event entry within the “events” attribute with the “event” attribute set to “UE TEMPORARILY UNAVAILABLE”.

The PCF shall reply to the NF service consumer as described in clause 4.2.2.2.

As a result of this action, the PCF shall set the appropriate subscription to notification of resources allocation outcome for the corresponding PCC Rule(s) as described in 3GPP TS 29.512 [8].

### 4.2.3.10 Modification of Subscription to Resources Allocation Outcome

This procedure is used in the NF service consumer to modify in the PCF the subscription to notification about resources allocation outcome.

The NF service consumer shall use the HTTP PATCH method to update the “Events Subscription” sub-resource together with the modifications to the “Individual Application Session Context” resource.

The NF service consumer shall include in the HTTP PATCH request message described in clause 4.2.3.2, in the “ascReqData” attribute, the updated values of the “EventsSubscReqDataRm” data type, which either include in the “events” attribute a new element with the “event” attribute set to “SUCCESSFUL_RESOURCES_ALLOCATION”, “FAILED_RESOURCES_ALLOCATION”, and/or “UE_TEMPORARILY UNAVAILABLE” or remove in the “events” attribute an existing element with the “event” attribute set to “SUCCESSFUL_RESOURCES_ALLOCATION”, “FAILED_RESOURCES_ALLOCATION” and/or “UE TEMPORARILY UNAVAILABLE”.

As a result of this action, the PCF shall set the appropriate subscription to notification of resources allocation outcome in the corresponding PCC Rule(s) as described in 3GPP TS 29.512 [8].

4.2.5.5 Notification about Service Data Flow Deactivation

When the PCF gets the knowledge that one or more SDFs have been deactivated, the PCF shall inform the NF service consumer accordingly if the NF service consumer has previously subscribed as described in clauses 4.2.2.7 and 4.2.3.7.

When not all the service data flows within the AF application session context are affected, the PCF shall notify the NF service consumer by including the “EventsNotification” data type in the body of the HTTP POST request as described in clause 4.2.5.2.

The PCF shall include within the “evNotifs” attribute an event of “AfEventNotification” data type indicating the matched event (“FAILED_RESOURCES_ALLOCATION” if the resources could not be allocated “UE TEMPORARILY UNAVAILABLE” if the UE was not reachable) in the “event” attribute and the deactivated service data flows (if not all the flows are affected) encoded in the “flows” attribute.

NOTE 1: If the PCF detects that the PCC rules related to an AF application session context cannot be installed or modified because there is a temporary network failure (e.g. SGW failed according to clause B.3.3.3 or B.3.4.9 of 3GPP TS 29.512 [8]) and if requested by the AF, the PCF can notify the AF of the event “FAILED_RESOURCES_ALLOCATION”.

If the “MediaComponentVersioning” feature is supported, and if the content version was included when the corresponding media component was provisioned as described in clause 4.2.5.8, the PCF shall also include in the “flows” attribute the “contVers” attribute with the content version(s) of the media components.

If the “RAN-NAS-Cause” feature is supported and the PCF received the RAN-NAS release cause and access network information from the SMF, the PCF shall provide in the “EventsNotification” data type of the HTTP POST request:
in case of 3GPP access, the user location information in the “eutraLocation” or in the “nrLocation” attribute in the “ueLoc” attribute, if available;
in case of untrusted non-3GPP access, the user location information in the “n3gaLocation” attribute in the “ueLoc” attribute, if available, as follows:
a) the user local IP address in the “ueIpv4Addr” or “ueIpv6Addr” attribute;
b) the UDP source port or the TCP source port in the “portNumber” and “protocol” attributes, if available; and
c) if the “WLAN_Location” feature is supported, the WLAN location information encoded in the “twapId” attribute, if available, that shall consist of:
i. the SSID in the “ssId” attribute;
ii. the BSSID the “bssId” attribute if available; and
iii, the civic address in the “civicAddress” attribute if available;

NOTE 2: When the UE reaches the ePDG via a NAT, the combination of UE local IP address and the UE source port is needed for lawful interception purposes. The UE source port may be either a UDP or a TCP port, and it is indicated in the “protocol” attribute.
in case of trusted non-3GPP access, the user location information in the “n3gaLocation” attribute in the “ueLoc” attribute, if available, as follows:
a) the user local IP address in the “ueIpv4Addr” or “ueIpv6Addr” attribute, if available; and
b) the UDP source port in the “portNumber” attribute if available; and NOTE 3: The UDP protocol can be used between the UE and the TNGF to enable NAT traversal.
c) either the TNAP identifier encoded in the “tnapId” attribute or the TWAP identifier encoded in the “twapId” attribute. The TNAP identifier and the TWAP identifier shall consist of:
i. the SSID in the “ssId” attribute;
ii. the BSSID the “bssId” attribute if available; and
iii, the civic address in the “civicAddress” attribute if available;
the serving network identity i.e. the PLMN Identifier (the PLMN network code and the country code) or the SNPN Identifier (the PLMN Identifier and the NID) in the “plmnId” attribute, if user location information is not available in any access;
the UE timezone in the “ueTimeZone” attribute if available; and
the RAN and/or NAS release cause in the “ranNasRelCauses” attribute, if available.

NOTE 4: The PCF forwards both 3GPP and non-3GPP access UE locations in the “ueLoc” attribute when both UE locations are provided by the SMF as defined in 3GPP TS 29.512 [8].

The PCF shall include in the “evNotifs” attribute, together with the event “FAILED_RESOURCES_ALLOCATION”, an event of the “AfEventNotification” data type with the “event” attribute set to the value “RAN_NAS_CAUSE”.

The PCF shall include more than one entry in the “contVers” attribute for the same media component if the PCF has received multiple content versions as described in clause 4.2.6.2.14 in 3GPP TS 29.512 [8].

When the NF service consumer receives the HTTP POST request, it shall acknowledge the request by sending a “204 No Content” response to the PCF. The NF service consumer may also update the AF application session context information by sending an HTTP PATCH request to the PCF.

When all the service data flows within the AF session are affected, the PCF shall inform the NF service consumer by sending a notification about application session context termination as defined in clause 4.2.5.3.

Signalling flows for Service Data Flow Deactivation cases are presented in 3GPP TS 29.513 [7].

4.2.5.8 Notification about Resources Allocation Outcome

When the PCF becomes aware that the resources associated to service information for one or more SDFs have been allocated, the PCF shall inform the NF service consumer accordingly if the NF service consumer has previously subscribed to the “SUCCESSFUL_RESOURCES_ALLOCATION” event as described in clauses 4.2.2.10 and 4.2.3.10. The PCF shall notify the NF service consumer by including the “EventsNotification” data type in the body of the HTTP POST request as described in clause 4.2.5.2. The PCF shall include in the “evNotifs” attribute an entry with the “event” attribute set to “SUCCESSFUL_RESOURCES_ALLOCATION” and (if not all the flows are affected) the identification of the related media components in the “flows” attribute. If the “MediaComponent Versioning” feature is supported, the PCF shall also include in the “flows” attribute the “contVers” attribute with the content version(s) of the media components if the content version was included when the corresponding media component was provisioned.

If the “Authorization WithRequiredQoS” feature or the “AltSerReqsWithIndQoS” feature as defined in clause 5.8 is supported, when the PCF becomes aware that the resources associated to service information for one or more SDFs have been allocated and additionally receives the alternative QoS parameter set(s), the PCF shall notify the NF service consumer by including the “EventsNotification” data type in the body of the HTTP POST request as described in clause 4.2.5.2. The PCF shall include:
an entry in the “evNotifs” attribute with the “event” attribute set to “SUCCESSFUL_RESOURCES_ALLOCATION”; and
the “succResourcAllocReports” attribute with the reference to the Alternative Service Requirement corresponding alternative QoS parameter set within the “altSerReq” attribute and the identification of the related media components in the “flows” attribute. If the “MediaComponentVersioning” feature is supported, the PCF shall also include in the “flows” attribute the “contVers” attribute with the content version(s) of the media components if the content version was included when the corresponding media component was provisioned.

When the PCF becomes aware that the resources associated to service information for one or more SDFs cannot be allocated, the PCF shall inform the NF service consumer accordingly if the NF service consumer has previously subscribed to the “FAILED_RESOURCES_ALLOCATION” event as described in clauses 4.2.2.10 and 4.2.3.10. The PCF shall notify the NF service consumer by including the “EventsNotification” data type in the body of the HTTP POST request as described in clause 4.2.5.2. The PCF shall include:
an entry in the “evNotifs” attribute with the “event” attribute set to “FAILED_RESOURCES_ALLOCATION”; and
the “failedResourcAllocReports” attribute with the active/inactive status of the PCC rules related to certain media components encoded in the “mcResourcStatus” attribute, and (if not all the flows are affected) the identification of the related media components in the “flows” attribute. If the “MediaComponentVersioning” feature is supported, the PCF shall also include in the “flows” attribute the “contVers” attribute with the content version(s) of the media components if the content version was included when the corresponding media component was provisioned.

When the feature “UEUnreachable” is supported and if the PCF becomes aware that the UE is unreachable and thus the resources associated to service information for one or more SDFs are not allocated, the PCF shall inform the NF service consumer accordingly if the NF service consumer has previously subscribed to the “UE TEMPORARILY UNAVAILABLE” event as described in clauses 4.2.2.10 and 4.2.3.10. The PCF shall notify the NF service consumer by including the “EventsNotification” data type in the body of the HTTP POST request as described in clause 4.2.5.2. The PCF shall include:
an entry in the “evNotifs” attribute with the “event” attribute set to “UE TEMPORARILY UNAVAILABLE”;
the “failedResourcAllocReports” attribute with the active/inactive status of the PCC rules related to certain media components encoded in the “mcResourcStatus” attribute, and (if not all the flows are affected) the identification of the related media components in the “flows” attribute. If the “MediaComponentVersioning” feature is supported, the PCF shall also include in the “flows” attribute the “contVers” attribute with the content version(s) of the media components if the content version was included when the corresponding media component was provisioned; and
the “retry After” attribute if this information was received from the SMF.

The PCF shall include more than one entry in the “contVers” attribute for the same media component if the PCF has received multiple content versions as described in clause 4.2.6.2.14 in 3GPP TS 29.512 [8].

NOTE: The NF service consumer will use the content version to identify the media component version that failed or succeeded when multiple provisions of the same media component occur in a short period of time. How the NF service consumer handles such situations is out of scope of this specification.

When the NF service consumer receives the HTTP POST request, it shall acknowledge the request by sending a “204 No Content” response to the PCF.

Signalling flows for resource allocation outcome are presented in 3GPP TS 29.513 [7].

### 5.6.2.11 Type AfEventNotification

TABLE 5.6.2.11-1
Definition of type AfEventNotification

| Attribute name | Data type | P | Cardinality | Description | Applicability |
|---|---|---|---|---|---|
| event | AfEvent | M | 1 | Notified Event. | |
| flows | array(Flows) | O | 1 . . . N | Affected Service Data Flows. | |
| retryAfter | Uinteger | | | Indicates the estimate | UEUn- |
| | | | | on how long it will | reachable |
| | | | | take before it can be | |
| | | | | considered the paging | |
| | | | | procedure as completed. It | |
| | | | | may be provided when the | |
| | | | | event attribute indicates | |
| | | | | UE TEMPORARILY | |
| | | | | UNAVAILABLE | |

### 5.6.3.7 Enumeration: AfEvent

The enumeration “AfEvent” represents the traffic events the PCF can notify to the NF service consumer.

TABLE 5.6.3.7-1
Enumeration AfEvent

| Enumeration value | Description | Applicability |
|---|---|---|
| ACCESS_TYPE_CHANGE | Access type change. | |
| ANI_REPORT | Access Network Information Report requested. | NetLoc |
| APP_DETECTION | Application detection report is requested. | ApplicationDetectionEvents |
| CHARGING_CORRELATION | Access Network Charging Correlation Information. | IMS_SBI |
| UP_PATH_CHG_FAILURE | Indicates that the enforcement of the AF required routing | RoutingReqOutcome |
| | requirements (i.e. DNAI change) failed. | |
| EPS_FALLBACK | Indicates that the establishment of the QoS flow for the | EPSFallbackReport |
| | requested voice media type was rejected due to fallback to | |
| | EPS. | |
| FAILED_QOS_UPDATE | Indicates that the invocation/revocation indication included in | MPSforDTS |
| | the mpsAction requested by the NF service consumer has | |
| | failed. | |
| FAILED_RESOURCES_{—} | Indicates that one or more of the SDFs of an Individual | |
| ALLOCATION | Application Session Context are deactivated at the SMF. It also | |
| | indicates that the resources requested for a particular service | |
| | information cannot be successfully allocated. | |
| OUT_OF_CREDIT | Out of credit. | IMS_SBI |
| PDU_SESSION_STATUS | Indicates the status of the PDU session | |
| | (established/terminated). It only applies to notifications to the | |
| | PCF for a UE as specified in clause 4.2.5.22. | |
| PLMN_CHG | This trigger indicates PLMN change. | |
| QOS_NOTIF | The GBR QoS targets of a SDF are not guaranteed or are | |
| | guaranteed again. | |
| QOS_MONITORING | Indicates PCF to enable Qos Monitoring for the Service Data | QoSMonitoring |
| | Flow. | |
| RAN_NAS_CAUSE | This trigger indicates RAN-NAS release cause information is | RAN-NAS-Cause |
| | available in the PCF from the SMF. | |
| | This event does not require explicit subscription. | |
| REALLOCATION_OF_CREDIT | Credit has been reallocated after a former out of credit | IMS_SBI, |
| | indication. | ReallocationOfCredit |
| SAT_CATEGORY_CHG | Indicates that the SMF has detected a change between | SatelliteBackhaul |
| | different satellite backhaul category, or non-satellite backhaul. | |
| SUCCESSFUL_QOS_UPDATE | Indicates that the invocation/revocation indication included in | MPSforDTS |
| | the mpsAction requested by the NF service consumer has been | |
| | successful. | |
| SUCCESSFUL_RESOURCES_{—} | Indicates that the resources requested for particular service | |
| ALLOCATION | information have been successfully allocated. | |
| TSN_BRIDGE_INFO | 5GS Bridge information (UMIC and/or PMIC(s)) received by the | TimeSensitiveNetworking |
| | PCF from the SMF. | |
| USAGE_REPORT | Volume and/or time usage for sponsored data connectivity. | SponsoredConnectivity |
| UE TEMPORARILY | UE is not reachable. | UEUnreachable |
| UNAVAILABLE | | |

The optional features in table 5.8-1 are defined for the Npcf_PolicyAuthorization API. They shall be negotiated using the extensibility mechanism defined in clause 6.6.2 of 3GPP TS 29.500 [5].

When requesting the PCF to create an Individual Application Session Context resource the NF service consumer shall indicate the optional features the NF service consumer supports for the Npcf_PolicyAuthorization service by including the “suppFeat” attribute in the “AppSessionContextReqData” data type of the HTTP POST request.

The PCF shall determine the supported features for the created Individual Application Session Context resource as specified in clause 6.6.2 of 3GPP TS 29.500 [5]. The PCF shall indicate the supported features in the HTTP response confirming the creation of the Individual Application Session Context resource by including the “suppFeat” attribute in the “AppSessionContextRespData” data type.

### 5.8 Feature Negotiation

TABLE 5.8-1
Supported Features

| Feature | | |
|---|---|---|
| number | Feature Name | Description |
| 1 | InfluenceOnTrafficRouting | Indicates support of Application Function influence on traffic |
| | | routing. If the PCF supports this feature, the NF service consumer |
| | | may influence SMF routing to applications or subscribe to |
| | | notifications of UP path management for the traffic flows of an |
| | | active PDU session. |
| 2 | SponsoredConnectivity | Indicates support of sponsored data connectivity. If the PCF |
| | | supports this feature, the NF service consumer may provide |
| | | sponsored data connectivity to the SUPI. |
| 3 | MediaComponentVersioning | Indicates the support of the media component versioning. |
| 4 | URLLC | Indicates support of Ultra-Reliable Low-Latency Communication |
| | | (URLLC) requirements, i.e. AF application relocation |
| | | acknowledgement and UE address(es) preservation. The |
| | | InfluenceOnTrafficRouting feature shall be supported in order to |
| | | support this feature. |
| 5 | IMS_SBI | Indicates support of the communication with the 5GC IMS NF |
| | | service consumer via Service Based Interfaces. |
| 6 | NetLoc | Indicates the support of access network information reporting. |
| 7 | ProvAFsignalFlow | This indicates support for the feature of provisioning of AF |
| | | signalling flow information as described in clauses 4.2.2.16 and |
| | | 4.2.3.17. If the PCF supports this feature the NF service consumer |
| | | may provision AF signalling flow information. |
| | | NOTE: This feature is used by the IMS Restoration Procedures |
| | | to provide to the SMF the address of the P-CSCF selected by the |
| | | UE, refer to 3GPP TS 23.380 [39]. |
| | | The IMS_SBI feature shall be supported in order to support this |
| | | feature. |
| 8 | ResourceSharing | This feature indicates the support of resource sharing across |
| | | several “Individual Application Session Context” resources. The |
| | | IMS_SBI feature shall be supported in order to support this feature. |
| 9 | MCPTT | This feature indicates the support of Mission Critical Push To Talk |
| | | services as described in 3GPP TS 24.379 [41]. |
| 10 | MCVideo | This feature indicates the support of Mission Critical Video services |
| | | as described in 3GPP TS 24.281 [43]. |
| 11 | PrioritySharing | This feature indicates that Priority Sharing is supported as |
| | | described in 3GPP TS 23.503 [4], clause 6.1.3.15. |
| 12 | MCPTT-Preemption | This feature indicates the support of service pre-emption based on |
| | | the information provided by the NF service consumer. It requires |
| | | that both PrioritySharing and MCPTT features are also supported. |
| 13 | MacAddressRange | Indicates the support of a set of MAC addresses with a specific |
| | | range in the traffic filter. |
| 14 | RAN-NAS-Cause | This feature indicates the support for the release cause code |
| | | information from the access network. |
| 15 | EnhancedSubscriptionToNotification | Indicates the support of: |
| | | Subscription to periodic notifications. |
| | | Definition of a waiting time between the reporting of two event |
| | | triggered events. |
| | | Indication of whether the event has to be reported at PDU |
| | | Session termination. |
| | | Notification Correlation Id for a subscription to an event. |
| 16 | QoSMonitoring | Indicates the support of QoS monitoring information. This feature |
| | | requires the support of the EnhancedSubscriptionToNotification |
| | | feature. |
| 17 | AuthorizationWithRequiredQoS | Indicates support of policy authorization for the AF session with |
| | | required QoS. |
| 18 | TimeSensitiveNetworking | Indicates that the 5G System is integrated within the external |
| | | network as a TSN bridge. |
| 19 | PCSCF-Restoration-Enhancement | This feature indicates support of P-CSCF Restoration |
| | | Enhancement. It is used for the PCF and the P-CSCF to indicate if |
| | | they support P-CSCF Restoration Enhancement. |
| 20 | CHEM | This feature indicates the support of Coverage and Handover |
| | | Enhancements for Media (CHEM). |
| 21 | FLUS | This feature indicates the support of FLUS functionality as |
| | | described in 3GPP TS 26.238 [51]. |
| 22 | EPSFallbackReport | This feature indicates the support of the report of EPS Fallback as |
| | | defined in clauses 4.2.2.30, 4.2.3.29 and 4.2.5.15. |
| 23 | ATSSS | Indicates the support of the report of the multiple access types of a |
| | | MA PDU session. |
| 24 | QoSHint | This feature indicates the support of specific QoS hint parameters |
| | | as described in 3GPP TS 26.114 [30], clause 6.2.10. |
| 25 | ReallocationOfCredit | This feature indicates the support of notifications of reallocation of |
| | | credits events. It requires the support of IMS_SBI feature. |
| 26 | ES3XX | Extended Support for 3xx redirections. This feature indicates the |
| | | support of redirection for any service operation, according to |
| | | Stateless NF procedures as specified in clauses 6.5.3.2 and |
| | | 6.5.3.3 of 3GPP TS 29.500 [5] and according to HTTP redirection |
| | | principles for indirect communication, as specified in clause 6.10.9 |
| | | of 3GPP TS 29.500 [5]. |
| 27 | DisableUENotification | Indicates the support of disabling QoS flow parameters signalling |
| | | to the UE when the SMF is notified by the NG-RAN of changes in |
| | | the fulfilled QoS situation. This feature requires that the |
| | | AuthorizationWithRequiredQoS featute is also supported. |
| 28 | PatchCorrection | Indicates support of the correction to the PATCH method: |
| | | When this feature is not supported, the interoperability between a |
| | | NF service consumer and the PCF can only be ensured when it is |
| | | not required the update of the Individual Application Session |
| | | Context resource. |
| 29 | MPSforDTS | Indicates support for MPS for DTS as described in clauses |
| | | 4.2.2.12.2 and 4.2.3.12. |
| 30 | ApplicationDetectionEvents | This feature indicates the support of the subscription to |
| | | notifications of the detection of the start and stop of an |
| | | application's traffic. |
| 31 | TimeSensitiveCommunication | Indicates that the 5G System is integrated within the external |
| | | network as a TSC user plane node to enable the Time Sensitive |
| | | Communications and Time Synchronization. This feature requires |
| | | that the TimeSensitiveNetworking feature is also supported. |
| 32 | ExposureToEAS | This feature indicates the support of the indication of direct event |
| | | notification of QoS monitoring events from the UPF to the Local |
| | | NEF or AF in 5GC. This indication requires that the QoSMonitoring |
| | | feature is supported. |
| 33 | SatelliteBackhaul | Indicates the support of the report of the satellite or non-satellite |
| | | backhaul category of the PDU session. |
| 34 | RoutingReqOutcome | Indicates the support of: |
| | | the report of UP path change failures; and |
| | | the indication of whether AF routing requirements are |
| | | applied. |
| | | It requires the support of InfluenceOnTrafficRouting feature. |
| 35 | EASDiscovery | This feature indicates the support of EAS (re)discovery. |
| 36 | AltSerReqsWithIndQoS | Indicates the support of provisioning Alternative Service |
| | | Requirements with individual QoS parameters. This feature |
| | | requires that the AuthorizationWithRequiredQoS feature is also |
| | | supported. |
| 37 | SimultConnectivity | This feature indicates the support of the indication of temporary |
| | | simultaneous connectivity over source and target PSA at edge |
| | | relocation. This indication requires that the |
| | | InfluenceOnTrafficRouting feature is supported. |
| 38 | EASIPreplacement | This feature indicates the support of provisioning of EAS IP |
| | | replacement info. This support requires that |
| | | InfluenceOnTrafficRouting feature is also supported |
| 39 | AccNetChargId_String | This feature indicates the support of long character strings as |
| | | access network charging identifier. |
| 40 | WLAN_Location | This feature indicates the support of the report of the WLAN |
| | | location information received from the ePDG/EPC, if available. It is |
| | | only applicable to EPS interworking scenarios as described in |
| | | 3GPP TS 29.512 [8], Annex B. |
| 41 | AF_latency | This feature indicates support for edge relocation considering user |
| | | plane latency. |
| 42 | UEUnreachable | This feature indicates the support for the reporting of UE not |
| | | reachable. |

Example embodiments are described herein with reference to block diagrams and/or flowchart illustrations of computer-implemented methods, apparatus (systems and/or devices) and/or non-transitory computer program products. It is understood that a block of the block diagrams and/or flowchart illustrations, and combinations of blocks in the block diagrams and/or flowchart illustrations, may be implemented by computer program instructions that are performed by one or more computer circuits. These computer program instructions may be provided to a processor circuit of a general purpose computer circuit, special purpose computer circuit, and/or other programmable data processing circuit to produce a machine, such that the instructions, which execute via the processor of the computer and/or other programmable data processing apparatus, transform and control transistors, values stored in memory locations, and other hardware components within such circuitry to implement the functions/acts specified in the block diagrams and/or flowchart block or blocks, and thereby create means (functionality) and/or structure for implementing the functions/acts specified in the block diagrams and/or flowchart block(s).

These computer program instructions may also be stored in a tangible computer-readable medium that may direct a computer or other programmable data processing apparatus to function in a particular manner, such that the instructions stored in the computer-readable medium produce an article of manufacture including instructions which implement the functions/acts specified in the block diagrams and/or flowchart block or blocks. Accordingly, embodiments of present inventive concepts may be embodied in hardware and/or in software (including firmware, resident software, micro-code, etc.) that runs on a processor such as a digital signal processor, which may collectively be referred to as “circuitry,” “a module” or variants thereof.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved. Moreover, the functionality of a given block of the flowcharts and/or block diagrams may be separated into multiple blocks and/or the functionality of two or more blocks of the flowcharts and/or block diagrams may be at least partially integrated. Finally, other blocks may be added/inserted between the blocks that are illustrated, and/or blocks/operations may be omitted without departing from the scope of inventive concepts. Moreover, although some of the diagrams include arrows on communication paths to show a primary direction of communication, it is to be understood that communication may occur in the opposite direction to the depicted arrows.

Many variations and modifications can be made to the embodiments without substantially departing from the principles of the present inventive concepts. All such variations and modifications are intended to be included herein within the scope of present inventive concepts. Accordingly, the above disclosed subject matter is to be considered illustrative, and not restrictive, and the appended examples of embodiments are intended to cover all such modifications, enhancements, and other embodiments, which fall within the spirit and scope of present inventive concepts. Thus, to the maximum extent allowed by law, the scope of present inventive concepts is to be determined by the broadest permissible interpretation of the present disclosure including the following examples of embodiments and their equivalents, and shall not be restricted or limited by the foregoing detailed description.

### Abbreviations

3GPP 3rd Generation Partnership Project
5G fifth generation of mobile communication technology
AF Application Function
AMF Access and Mobility Management Function
DDN Downlink Data Notification
HTTP Hyper Text Transfer Protocol
LMF Location Management Function
NF Network Function
OTT Over The Top
PCC Policy and Charging Control
PCF Policy Control Function
PDU Packet Data Unit
RAN Radio Access Network
SMF Session Management Function
SMSF Short Message Service Function
UDM Unified Data Management
UE User Equipment.
UPF User Plane Function
URI Uniform Resource Identifier.

1. A method performed by a second network function implementing a Session Management Function (SMF), comprising:
receiving, from a first network function implementing an Access and Mobility Management Function (AMF), a first message including a first parameter indicating a first retry-after time, wherein the first retry-after time indicates the second network function to stop sending a message for a User Equipment (UE) before the first retry-after time is timeout; and
transmitting based on the first message, to a third network function implementing a Policy Control Function (PCF), a second message including a second parameter indicating a second retry-after time during which the UE is considered unreachable.

2. The method according to claim 1, wherein the second retry-after time is set based on the first retry-after time.

3. The method according to claim 1, wherein the first and second messages each further includes a fourth parameter indicating a failure cause; and
wherein the failure cause is that the UE is temporarily unavailable.

4. The method according to claim 3, further comprising:
receiving (S503), from the third network function, a fifth message for retrying the failed policy update or sending the buffered changes, after the second retry-after timer expires.

5. The method according to claim 1, wherein the first message is N1N2 message transfer response message or N1N2 message transfer failure notification message;
the second message is a session management policy control update request message; or
the fifth message is a session management policy control update notify request message.

6. A method performed by a third network function implementing a Policy Control Function (PCF), comprising:
receiving, from a second network function implementing a Session Management Function (SMF), a second message including a second parameter indicating a second retry-after time during which a User Equipment (UE) is considered unreachable; and
transmitting, to a fourth network function implementing an Application Function (AF), a third message including a third parameter indicating a third retry-after time, wherein the third retry-after time indicates the fourth network function to suppress a transfer of message to the third network function when the third retry-after time runs.

7. The method according to claim 6, wherein the second and third messages each further includes a fourth parameter indicating a failure cause; and
wherein the failure cause is that the UE is temporarily unavailable.

8. The method according to claim 6, further comprising:
receiving, from the fourth network function, a subscription on a failure event, and
wherein the third message is transmitted in response to the failure event.

9. The method according to claim 8, further comprising:
receiving, from the fourth network function, a fourth message for retrying the provisioning of application or service information, after the third retry-after time expires; and
transmitting, to the second network function, a fifth message for retrying the failed policy update or sending the buffered changes, in response to the fourth message.

10. The method according to claim 9, wherein the second message is a session management policy control update request message;
wherein the third message is an event reporting message;
wherein the fourth message is an application/service information provisioning message; or
wherein the fifth message is a session management policy control update notify request message.

11. The method according to claim 10, wherein the session management policy is a Policy and Charging Control (PCC) rule.

12. A method performed by a fourth network function implementing an Application Function (AF), comprising:
receiving, from a third network function implementing a Policy Control Function (PCF), a third message including a third parameter indicating a third retry-after time, wherein the third retry-after time indicates the fourth network function to suppress a transfer of message to the third network function during the third retry-after time.

13. The method according to claim 12, further comprising:
starting a retry-after timer according to the third parameter, to suppress a transfer of message to the third network function when the retry-after timer runs.

14. The method according to claim 12, wherein the third message further includes a fourth parameter indicating a failure cause; and
wherein the failure cause is that a User Equipment is temporarily unavailable.

15. The method according to claim 12, further comprising:
transmitting, to the third network function, a subscription on a failure event, and
wherein the third message is transmitted in response to the failure event.

16. The method according to claim 15, further comprising:
transmitting, to the third network function, a fourth message for retrying the provisioning of application or service information, after the retry-after timer expires.

17. The method according to claim 16, wherein the third message is an event reporting message; or
wherein the fourth message is a session management policy control update notify request message.

18. The method according to claim 17, wherein the session management policy is a Policy and Charging Control (PCC) rule.

19-23. (canceled)
